(19) United States
(12) Patent Application Publication
(10) Pub. No.: US 2018/0281597 A1
(43) Pub. Date: Oct. 4, 2018

(54) ELECTRIC VEHICLE SAFETY CONCEPT USING DISTRIBUTED VEHICLE CONTROL UNITS

(71) Applicant: NextEV USA, Inc., San Jose, CA (US)

(72) Inventor: Robert Herb, Morgan Hill, CA (US)

(21) Appl. No.: 15/471,822

(22) Filed: Mar. 28, 2017

(51) Int. Cl. B60L 3/00; B60L 15/20; B60K 1/02

(52) U.S. Cl. CPC B60L 3/0084; B60L 15/20; B60K 1/02; B60L 2240/423; B60Y 2300/60; B60L 2240/14; B60L 2240/24; B60L 2240/12; B60L 2240/48

(57) ABSTRACT

Systems of an electrical vehicle and the operations thereof are provided. Embodiments include an electric vehicle, rechargeable electric vehicle, and/or hybrid-electric vehicle and associated systems. The electric vehicle includes redundant vehicle control systems that monitor each other to prevent a dangerous reduction or change in torque to the electric motor(s). By monitoring each other, the redundant VCUs can ensure that a failure of the opposite VCU does not endanger the vehicle and may be shut down when the opposite VCU when the VCU's behavior is outside acceptable operating circumstances.

### FIELD

The present disclosure is generally directed to vehicle systems, in particular, toward control systems for controlling electric and/or hybrid-electric vehicles.

### BACKGROUND

In recent years, transportation methods have changed substantially. This change is due in part to a concern over the limited availability of natural resources, a proliferation in personal technology, and a societal shift to adopt more environmentally friendly transportation solutions. These considerations have encouraged the development of several new flexible-fuel vehicles, hybrid-electric vehicles, and electric vehicles.

In current electric vehicles, loss of torque can be dangerous. Controlling the motor(s) to eliminate situations where a loss of torque occurs is in an important safety consideration. Generally, a Vehicle Control Unit (VCU) controls the torque instructions sent to the motor based on readings from the acceleration pedal, the brake pedal, and the gear shifter, etc. In electric vehicles, the VCU is generally a single point of failure, which can make the electric vehicle more susceptible to loss of torque situations.

### BRIEF DESCRIPTION OF THE DRAWINGS

FIG. 1 shows a vehicle in accordance with embodiments of the present disclosure;

FIG. 2 shows a plan view of the vehicle in accordance with at least some embodiments of the present disclosure;

FIG. 3 shows a plan view of the vehicle in accordance with embodiments of the present disclosure;

FIG. 4 shows an embodiment of the instrument panel of the vehicle in accordance with embodiments of the present disclosure;

FIG. 5 is a block diagram of an embodiment of an electrical system of the vehicle;

FIG. 6 is a block diagram of an embodiment of a power generation unit associated with the electrical system of the vehicle;

FIG. 7 is a block diagram of an embodiment of power storage associated with the electrical system of the vehicle;

FIG. 8 is a block diagram of an embodiment of loads associated with the electrical system of the vehicle;

FIG. 9 is a block diagram of an embodiment of a communications subsystem of the vehicle;

FIG. 10 is a block diagram of a computing environment associated with the embodiments presented herein;

FIG. 11 is a block diagram of a computing device associated with one or more components described herein;

FIG. 12 shows an embodiment of a vehicle with a redundant vehicle control system;

FIG. 13A is an embodiment of a vehicle control system with redundant components;

FIG. 13B is a data diagram showing an embodiment of rules used by the vehicle control system to control the torque requested from the motor(s);

FIG. 13C is a block diagram showing an embodiment of VCU component to control the torque requested for the motor(s);

FIG. 14 is a signaling diagram showing an embodiment of the internal signaling in the vehicle control system;

FIG. 15 is a method diagram providing an embodiment of a method for controlling an electric motor in an electric vehicle;

FIG. 16 is another method diagram providing another embodiment of a method for controlling an electric motor in an electric vehicle.

### DETAILED DESCRIPTION

Embodiments of the present disclosure will be described in connection with a vehicle, and in some embodiments, an electric vehicle, rechargeable electric vehicle, and/or hybrid-electric vehicle and associated systems. The vehicle includes redundant vehicle control systems that monitor each other to prevent a dangerous reduction or change in torque to the electric motor(s). By monitoring each other, the redundant VCUs can ensure that a failure of the opposite VCU does not endanger the vehicle and may be shut down when the VCU's behavior is outside acceptable operating circumstances.

The vehicle control systems are connected to the various vehicle systems, e.g., the brake pedal, the accelerator pedal, the gear shifter, etc. These connections can be analog or digital, e.g. Controller Area Network (CAN) communication. The vehicle control systems can communicate to the high voltage battery system and, for full redundancy, the high voltage battery system may be redundant having a second high voltage battery and a first high voltage battery.

The second vehicle control system communicates the desired motor torque to the second power electronics unit (PEU). This communication can be analog or digital, e.g. CAN communication. The first vehicle control system communicates the desired motor torque to the first PEU. This communication can be analog or digital, e.g., CAN communication. The second vehicle control system and the first vehicle control system communicate with each other, e.g. via CAN.

The second PEU provides a high voltage, high current, three phase signal to the second motor. The second motor transforms the electrical energy into mechanical power. The first PEU provides a high voltage, high current, three phase signal to the first motor. The first motor transforms the electrical energy into mechanical power.

The second vehicle control system is connected to the second PEU by a switch off path line. The switch off path line can be analog or digital. With the help of the switch off path line, the second vehicle control system can turn off the high voltage, high current, three phase signal, which the second PEU provides to the second motor and therefore can cut off torque produced by the second motor. The first vehicle control system is connected to the first PEU by a second switch off path line. With the help of the second switch off path line, the first vehicle control system can turn off the high voltage, high current, three phase signal, which the first PEU provides to the first motor and therefore can cut off torque produced by the first motor.

With the help of a third switch off path line, the second vehicle control system can turn off the high voltage, high current, three phase signal which the first PEU provides to the first motor and therefore can cut off torque produced by the first motor. With the help of a fourth switch off path line, the first vehicle control system can turn off the high voltage, high current, three phase signal, which the second PEU provides to the second motor and therefore can cut off torque produced by the second motor.

The second vehicle control system can continuously monitor the brake pedal position, the accelerator pedal position, the gear shifter position, etc. Additionally, the second vehicle control system reads other signals from other Electronic Control Units (ECU) of the vehicle, for example, wheel speeds and jaw rate. The first vehicle control system can also continuously monitor the brake pedal position, the accelerator pedal position, the gear shifter position, etc. Additionally, the first vehicle control system reads other signals from other ECUs, for example, wheel speeds and jaw rate.

The second vehicle control system continuously calculates the requested torque for the second motor derived out of the signals provided from brake pedal, accelerator pedal, gear shifter, the other ECUs, etc. The second vehicle control system communicates that requested torque to the first vehicle control system. Likewise, the first vehicle control system continuously calculates the requested torque for the first motor derived out of the signals provided from brake pedal, accelerator pedal, gear shifter, the other ECUs, etc. The first vehicle control system communicates that requested torque to the second vehicle control system.

The second vehicle control system continuously calculates the minimum out of the requested torque for the second motor calculated by the second vehicle control system and the requested torque for the second motor calculated and communicated by the first vehicle control system. The second vehicle control system communicates that calculated minimum to the second PEU. The first vehicle control system continuously calculates the minimum out of the requested torque for the first motor calculated by the first vehicle control system and the requested torque for the first motor calculated and communicated by the second vehicle control system. The first vehicle control system communicates that calculated minimum to the first PEU.

The second vehicle control system compares the requested torque for the first motor calculated by the second vehicle control system with the one calculated and communicated to the first PEU by the first vehicle control system. In cases where the second vehicle control system detects that the first vehicle control system communicates a higher requested torque to the first PEU than calculated by the second vehicle control system, the second vehicle control system can cut off torque produced by the first motor by activating the switch off path. Similarly, the first vehicle control system compares the requested torque for the second motor calculated by the first vehicle control system with the one calculated and communicated to the second PEU by the second vehicle control system. In cases where the first vehicle control system detects that the second vehicle control system communicates a higher requested torque to the second PEU than calculated by the first vehicle control system, the first vehicle control system will cut off torque produced by the second motor by activating the switch off path.

The second PEU continuously calculates the torque produced by the second motor. The second PEU communicates that calculated torque to the second vehicle control system. The second vehicle control system compares the torque produced by the second motor with the requested torque for the second motor calculated by the second vehicle control system. In cases where the second vehicle control system detects that the torque produced by the second motor is higher than the requested torque for the second motor calculated by the second vehicle control system, the second vehicle control system can cut off torque produced by the second motor by activating the switch off path.

Also, the first PEU continuously calculates the torque produced by the first motor. The first PEU communicates that calculated torque to the first vehicle control system. The first vehicle control system compares the torque produced by the first motor with the requested torque for the first motor calculated by the first vehicle control system. In cases where the first vehicle control system detects that the torque produced by the first motor is higher than the requested torque for the first motor calculated by the first vehicle control system, the first vehicle control system may cut off torque produced by the first motor by activating the switch off path.

The redundancy of the vehicle control system and the mutual monitoring of the redundant systems ensures a safer driving system. Torque calculations by the various systems and cross checks of the calculated or sensed or estimated torque prevent an incorrect torque being applied by the motors. Thus, the vehicle is safer and more robust.

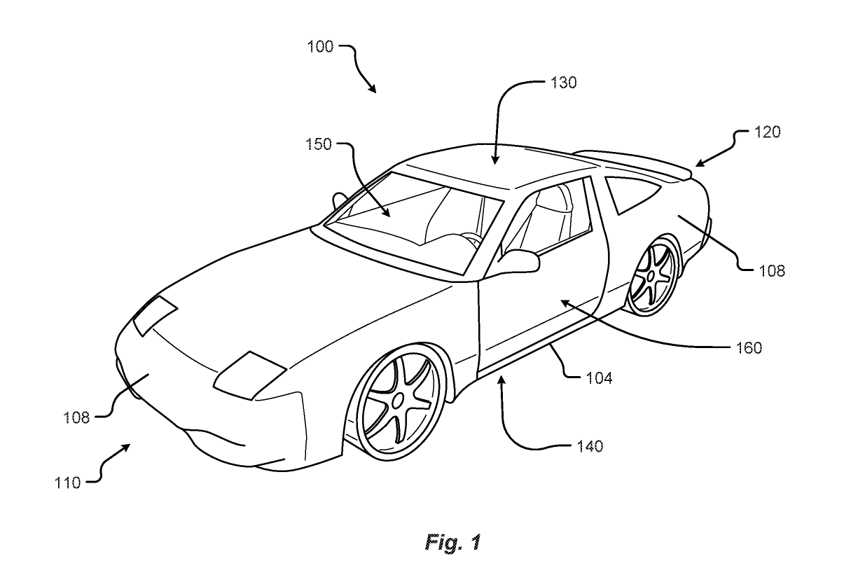

FIG. 1 shows a perspective view of a vehicle 100 in accordance with embodiments of the present disclosure. The electric vehicle 100 comprises a vehicle front 110, vehicle aft 120, vehicle roof 130, at least one vehicle side 160, a vehicle undercarriage 140, and a vehicle interior 150. In any event, the vehicle 100 may include a frame 104 and one or more body panels 108 mounted or affixed thereto. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components, etc.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, busses, automobiles, trains, railed conveyances, boats, ships, marine conveyances, submarine conveyances, airplanes, space craft, flying machines, human-powered conveyances, and the like.

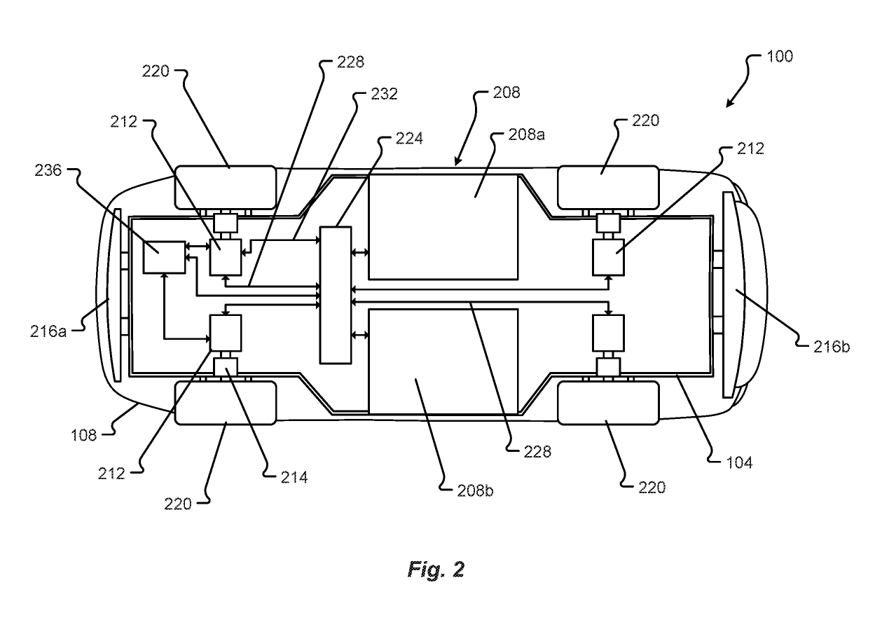

Referring now to FIG. 2, a plan view of a vehicle 100 will be described in accordance with embodiments of the present disclosure. As provided above, the vehicle 100 may comprise a number of electrical and/or mechanical systems, subsystems, etc. The mechanical systems of the vehicle 100 can include structural, power, safety, and communications subsystems, to name a few. While each subsystem may be described separately, it should be appreciated that the components of a particular subsystem may be shared between one or more other subsystems of the vehicle 100.

The structural subsystem includes the frame 104 of the vehicle 100. The frame 104 may comprise a separate frame and body construction (i.e., body-on-frame construction), a unitary frame and body construction (i.e., a unibody construction), or any other construction defining the structure of the vehicle 100. The frame 104 may be made from one or more materials including, but in no way limited to steel, titanium, aluminum, carbon fiber, plastic, polymers, etc., and/or combinations thereof. In some embodiments, the frame 104 may be formed, welded, fused, fastened, pressed, etc., combinations thereof, or otherwise shaped to define a physical structure and strength of the vehicle 100. In any event, the frame 104 may comprise one or more surfaces, connections, protrusions, cavities, mounting points, tabs, slots, or other features that are configured to receive other components that make up the vehicle 100. For example, the body panels 108, powertrain subsystem, controls systems, interior components, communications subsystem, and safety subsystem may interconnect with, or attach to, the frame 104 of the vehicle 100.

The frame 104 may include one or more modular system and/or subsystem connection mechanisms. These mechanisms may include features that are configured to provide a selectively interchangeable interface for one or more of the systems and/or subsystems described herein. The mechanisms may provide for a quick exchange, or swapping, of components while providing enhanced security and adaptability over conventional manufacturing or attachment. For instance, the ability to selectively interchange systems and/or subsystems in the vehicle 100 allow the vehicle 100 to adapt to the ever-changing technological demands of society and advances in safety. Among other things, the mechanisms may provide for the quick exchange of batteries, capacitors, power sources 208a, 208b, motors 212, engines, safety equipment, controllers, user interfaces, interiors exterior components, body panels 108, bumpers 216a, 216b, sensors, etc., and/or combinations thereof. Additionally or alternatively, the mechanisms may provide unique security hardware and/or software embedded therein that, among other things, can prevent fraudulent or low quality construction replacements from being used in the vehicle 100. Similarly, the mechanisms, subsystems, and/or receiving features in the vehicle 100 may employ poka-yoke, or mistake-proofing, features that ensure a particular mechanism is always interconnected with the vehicle 100 in a correct position, function, etc.

By way of example, complete systems or subsystems may be removed and/or replaced from a vehicle 100 utilizing a single-minute exchange (“SME”) principle. In some embodiments, the frame 104 may include slides, receptacles, cavities, protrusions, and/or a number of other features that allow for quick exchange of system components. In one embodiment, the frame 104 may include tray or ledge features, mechanical interconnection features, locking mechanisms, retaining mechanisms, etc., and/or combinations thereof. In some embodiments, it may be beneficial to quickly remove a used power source 208a, 208b (e.g., battery unit, capacitor unit, etc.) from the vehicle 100 and replace the used power source 208a, 208b with a charged or new power source. Continuing this example, the power source 208a, 208b may include selectively interchangeable features that interconnect with the frame 104 or other portion of the vehicle 100. For instance, in a power source 208a, 208b replacement, the quick release features may be configured to release the power source 208a, 208b from an engaged position and slide or move in a direction away from the frame 104 of a vehicle 100. Once removed, or separated from, the vehicle, the power source 208a, 208b may be replaced (e.g., with a new power source, a charged power source, etc.) by engaging the replacement power source into a system receiving position adjacent to the vehicle 100. In some embodiments, the vehicle 100 may include one or more actuators configured to position, lift, slide, or otherwise engage the replacement power source with the vehicle 100. In one embodiment, the replacement power source may be inserted into the vehicle 100 or vehicle frame 104 with mechanisms and/or machines that are external and/or separate from the vehicle 100.

In some embodiments, the frame 104 may include one or more features configured to selectively interconnect with other vehicles and/or portions of vehicles. These selectively interconnecting features can allow for one or more vehicles to selectively couple together and decouple for a variety of purposes. For example, it is an aspect of the present disclosure that a number of vehicles may be selectively coupled together to share energy, increase power output, provide security, decrease power consumption, provide towing services, and/or provide a range of other benefits. Continuing this example, the vehicles may be coupled together based on travel route, destination, preferences, settings, sensor information, and/or some other data. The coupling may be initiated by at least one controller of the vehicle and/or traffic control system upon determining that a coupling is beneficial to one or more vehicles in a group of vehicles or a traffic system. As can be appreciated, the power consumption for a group of vehicles traveling in a same direction may be reduced or decreased by removing any aerodynamic separation between vehicles. In this case, the vehicles may be coupled together to subject only the foremost vehicle in the coupling to air and/or wind resistance during travel. In one embodiment, the power output by the group of vehicles may be proportionally or selectively controlled to provide a specific output from each of the one or more of the vehicles in the group.

The interconnecting, or coupling, features may be configured as electromagnetic mechanisms, mechanical couplings, electromechanical coupling mechanisms, etc., and/or combinations thereof. The features may be selectively deployed from a portion of the frame 104 and/or body of the vehicle 100. In some cases, the features may be built into the frame 104 and/or body of the vehicle 100. In any event, the features may deploy from an unexposed position to an exposed position or may be configured to selectively engage/disengage without requiring an exposure or deployment of the mechanism from the frame 104 and/or body of the vehicle 100. In some embodiments, the interconnecting features may be configured to interconnect one or more of power, communications, electrical energy, fuel, and/or the like. One or more of the power, mechanical, and/or communications connections between vehicles may be part of a single interconnection mechanism. In some embodiments, the interconnection mechanism may include multiple connection mechanisms. In any event, the single interconnection mechanism or the interconnection mechanism may employ the poka-yoke features as described above.

The power system of the vehicle 100 may include the powertrain, power distribution system, accessory power system, and/or any other components that store power, provide power, convert power, and/or distribute power to one or more portions of the vehicle 100. The powertrain may include the one or more electric motors 212 of the vehicle 100 (for example, the vehicle 100 shown in FIG. 2 has four motors 212). The electric motors 212 are configured to convert electrical energy provided by a power source into mechanical energy. This mechanical energy may be in the form of a rotational or other output force that is configured to propel or otherwise provide a motive force for the vehicle 100.

In some embodiments, the vehicle 100 may include one or more drive wheels 220 that are driven by the one or more electric motors 212 and motor controllers 214. In some cases, the vehicle 100 may include an electric motor 212 configured to provide a driving force for each drive wheel 220. In other cases, a single electric motor 212 may be configured to share an output force between two or more drive wheels 220 via one or more power transmission components. It is an aspect of the present disclosure that the powertrain may include one or more power transmission components, motor controllers 214, and/or power controllers that can provide a controlled output of power to one or more of the drive wheels 220 of the vehicle 100. The power transmission components, power controllers, or motor controllers 214 may be controlled by at least one other vehicle controller or computer system as described herein.

As provided above, the powertrain of the vehicle 100 may include one or more power sources 208a, 208b. These one or more power sources 208a, 208b may be configured to provide drive power, system and/or subsystem power, accessory power, etc. While described herein as a single power source 208 for sake of clarity, embodiments of the present disclosure are not so limited. For example, it should be appreciated that independent, different, or separate power sources 208a, 208b may provide power to various systems of the vehicle 100. For instance, a drive power source may be configured to provide the power for the one or more electric motors 212 of the vehicle 100, while a system power source may be configured to provide the power for one or more other systems and/or subsystems of the vehicle 100. Other power sources may include an accessory power source, a backup power source, a critical system power source, and/or other separate power sources. Separating the power sources 208a, 208b in this manner may provide a number of benefits over conventional vehicle systems. For example, separating the power sources 208a, 208b allow one power source 208 to be removed and/or replaced independently without requiring that power be removed from all systems and/or subsystems of the vehicle 100 during a power source 208 removal/replacement. For instance, one or more of the accessories, communications, safety equipment, and/or backup power systems, etc., may be maintained even when a particular power source 208a, 208b is depleted, removed, or becomes otherwise inoperable.

In some embodiments, the drive power source may be separated into two or more cells, units, sources, and/or systems. By way of example, a vehicle 100 may include a first drive power source 208a and a second drive power source 208b. The first drive power source 208a may be operated independently from or in conjunction with the second drive power source 208b and vice versa. Continuing this example, the first drive power source 208a may be removed from a vehicle while a second drive power source 208b can be maintained in the vehicle 100 to provide drive power. This approach allows the vehicle 100 to significantly reduce weight (e.g., of the first drive power source 208a, etc.) and improve power consumption, even if only for a temporary period of time. In some cases, a vehicle 100 running low on power may automatically determine that pulling over to a rest area, emergency lane, and removing, or “dropping off,” at least one power source 208a, 208b may reduce enough weight of the vehicle 100 to allow the vehicle 100 to navigate to the closest power source replacement and/or charging area. In some embodiments, the removed, or “dropped off,” power source 208a may be collected by a collection service, vehicle mechanic, tow truck, or even another vehicle or individual.

The power source 208 may include a GPS or other geographical location system that may be configured to emit a location signal to one or more receiving entities. For instance, the signal may be broadcast or targeted to a specific receiving party. Additionally or alternatively, the power source 208 may include a unique identifier that may be used to associate the power source 208 with a particular vehicle 100 or vehicle user. This unique identifier may allow an efficient recovery of the power source 208 dropped off. In some embodiments, the unique identifier may provide information for the particular vehicle 100 or vehicle user to be billed or charged with a cost of recovery for the power source 208.

The power source 208 may include a power management controller/power electronics unit 224 that may be configured to determine charge levels of the power source 208, control a rate at which charge is drawn from the power source 208, control a rate at which charge is added to the power source 208, and/or monitor a health of the power source 208 (e.g., one or more cells, portions, etc.). In some embodiments, the power management controller/power electronics unit 224 or the power source 208 may include a communication interface. The communication interface can allow the power management controller/power electronics unit 224 to report a state of the power source 208 to one or more other controllers of the vehicle 100 or even communicate with a communication device separate and/or apart from the vehicle 100. Additionally or alternatively, the communication interface may be configured to receive instructions (e.g., control instructions, charge instructions, communication instructions, etc.) from one or more other controllers or computers of the vehicle 100 or a communication device that is separate and/or apart from the vehicle 100.

The powertrain includes one or more power distribution systems configured to transmit power from the power source 208 to one or more electric motors 212 in the vehicle 100. The power distribution system may include electrical interconnections 228 in the form of cables, wires, traces, wireless power transmission systems, etc., and/or combinations thereof. It is an aspect of the present disclosure that the vehicle 100 include one or more redundant electrical interconnections 232 of the power distribution system. The redundant electrical interconnections 232 can allow power to be distributed to one or more systems and/or subsystems of the vehicle 100 even in the event of a failure of an electrical interconnection portion of the vehicle 100 (e.g., due to an accident, mishap, tampering, or other harm to a particular electrical interconnection, etc.). In some embodiments, a user of a vehicle 100 may be alerted via a user interface associated with the vehicle 100 that a redundant electrical interconnection 232 is being used and/or damage has occurred to a particular area of the vehicle electrical system. In any event, the one or more redundant electrical interconnections 232 may be configured along completely different routes than the electrical interconnections 228 and/or include different modes of failure than the electrical interconnections 228 to, among other things, prevent a total interruption power distribution in the event of a failure.

In some embodiments, the power distribution system may include an energy recovery system 236. This energy recovery system 236, or kinetic energy recovery system, may be configured to recover energy produced by the movement of a vehicle 100. The recovered energy may be stored as electrical and/or mechanical energy. For instance, as a vehicle 100 travels or moves, a certain amount of energy is required to accelerate, maintain a speed, stop, or slow the vehicle 100. In any event, a moving vehicle has a certain amount of kinetic energy. When brakes are applied in a typical moving vehicle, most of the kinetic energy of the vehicle is lost as the generation of heat in the braking mechanism. In an energy recovery system 236, when a vehicle 100 brakes, at least a portion of the kinetic energy is converted into electrical and/or mechanical energy for storage. Mechanical energy may be stored as mechanical movement (e.g., in a flywheel, etc.) and electrical energy may be stored in batteries, capacitors, and/or some other electrical storage system. In some embodiments, electrical energy recovered may be stored in the power source 208. For example, the recovered electrical energy may be used to charge the power source 208 of the vehicle 100.

The vehicle 100 may include one or more safety systems. Vehicle safety systems can include a variety of mechanical and/or electrical components including, but in no way limited to, low impact or energy-absorbing bumpers 216A, 216B, crumple zones, reinforced body panels, reinforced frame components, impact bars, power source containment zones, safety glass, seatbelts, supplemental restraint systems, air bags, escape hatches, removable access panels, impact sensors, accelerometers, vision systems, radar systems, etc., and/or the like. In some embodiments, the one or more of the safety components may include a safety sensor or group of safety sensors associated with the one or more of the safety components. For example, a crumple zone may include one or more strain gages, impact sensors, pressure transducers, etc. These sensors may be configured to detect or determine whether a portion of the vehicle 100 has been subjected to a particular force, deformation, or other impact. Once detected, the information collected by the sensors may be transmitted or sent to one or more of a controller of the vehicle 100 (e.g., a safety controller, vehicle controller, etc.) or a communication device associated with the vehicle 100 (e.g., across a communication network, etc.).

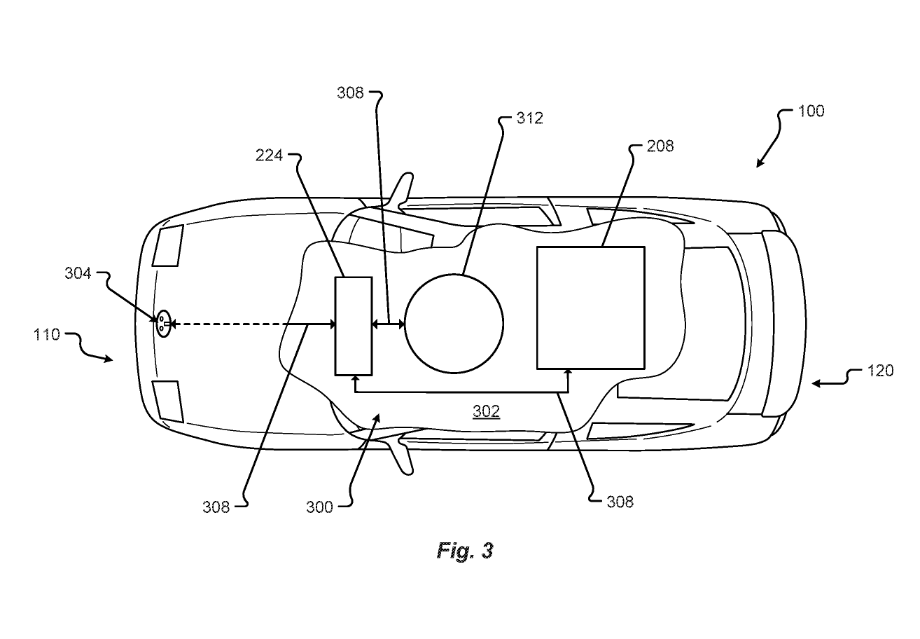

FIG. 3 shows a plan view of the vehicle 100 in accordance with embodiments of the present disclosure. In particular, FIG. 3 shows a broken section 302 of a charging system 300 for the vehicle 100. The charging system 300 may include a plug or receptacle 304 configured to receive power from an external power source (e.g., a source of power that is external to and/or separate from the vehicle 100, etc.). An example of an external power source may include the standard industrial, commercial, or residential power that is provided across power lines. Another example of an external power source may include a proprietary power system configured to provide power to the vehicle 100. In any event, power received at the plug/receptacle 304 may be transferred via at least one power transmission interconnection 308. Similar, if not identical, to the electrical interconnections 228 described above, the at least one power transmission interconnection 308 may be one or more cables, wires, traces, wireless power transmission systems, etc., and/or combinations thereof. Electrical energy in the form of charge can be transferred from the external power source to the power management controller/power electronics unit 224. As provided above, the power management controller/power electronics unit 224 may regulate the addition of charge to at least one power source 208 of the vehicle 100 (e.g., until the at least one power source 208 is full or at a capacity, etc.).

In some embodiments, the vehicle 100 may include an inductive charging system and inductive charger 312. The inductive charger 312 may be configured to receive electrical energy from an inductive power source external to the vehicle 100. In one embodiment, when the vehicle 100 and/or the inductive charger 312 is positioned over an inductive power source external to the vehicle 100, electrical energy can be transferred from the inductive power source to the vehicle 100. For example, the inductive charger 312 may receive the charge and transfer the charge via at least one power transmission interconnection 308 to the charge controller 324 and/or the power source 208 of the vehicle 100. The inductive charger 312 may be concealed in a portion of the vehicle 100 (e.g., at least partially protected by the frame 104, one or more body panels 108, a shroud, a shield, a protective cover, etc., and/or combinations thereof) and/or may be deployed from the vehicle 100. In some embodiments, the inductive charger 312 may be configured to receive charge only when the inductive charger 312 is deployed from the vehicle 100. In other embodiments, the inductive charger 312 may be configured to receive charge while concealed in the portion of the vehicle 100.

In addition to the mechanical components described herein, the vehicle 100 may include a number of user interface devices. The user interface devices receive and translate human input into a mechanical movement or electrical signal or stimulus. The human input may be one or more of motion (e.g., body movement, body part movement, in two-dimensional or three-dimensional space, etc.), voice, touch, and/or physical interaction with the components of the vehicle 100. In some embodiments, the human input may be configured to control one or more functions of the vehicle 100 and/or systems of the vehicle 100 described herein. User interfaces may include, but are in no way limited to, at least one graphical user interface of a display device, steering wheel or mechanism, transmission lever or button (e.g., including park, neutral, reverse, and/or drive positions, etc.), throttle control pedal or mechanism, brake control pedal or mechanism, power control switch, communications equipment, etc.

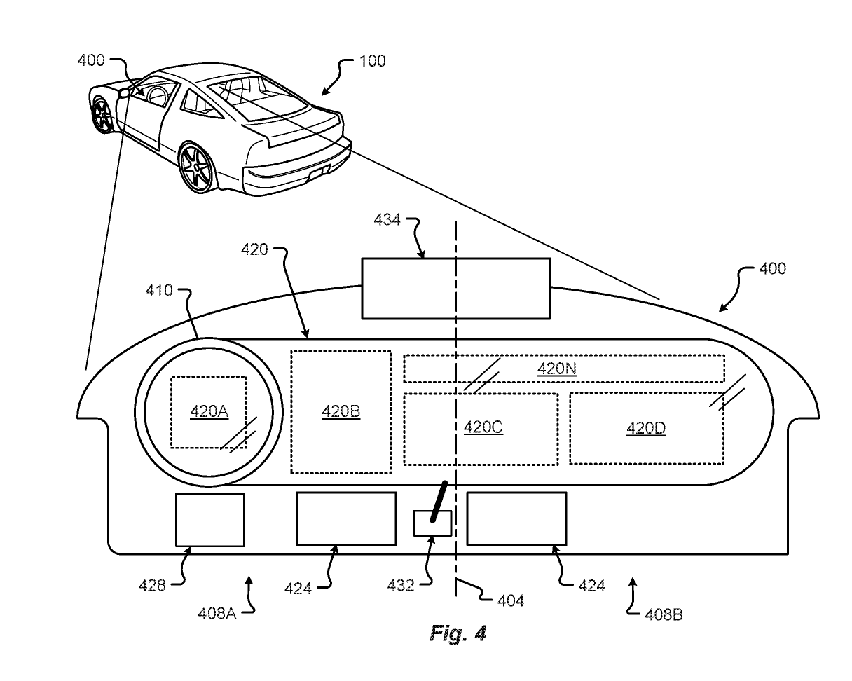

FIG. 4 shows one embodiment of the instrument panel 400 of the vehicle 100. The instrument panel 400 of vehicle 100 comprises a steering wheel 410, a vehicle operational display 420 (e.g., configured to present and/or display driving data such as speed, measured air resistance, vehicle information, entertainment information, etc.), one or more auxiliary displays 424 (e.g., configured to present and/or display information segregated from the operational display 420, entertainment applications, movies, music, etc.), a heads-up display 434 (e.g., configured to display any information previously described including, but in no way limited to, guidance information such as route to destination, or obstacle warning information to warn of a potential collision, or some or all primary vehicle operational data such as speed, resistance, etc.), a power management display 428 (e.g., configured to display data corresponding to electric power levels of vehicle 100, reserve power, charging status, etc.), and an input device 432 (e.g., a controller, touchscreen, or other interface device configured to interface with one or more displays in the instrument panel or components of the vehicle 100. The input device 432 may be configured as a joystick, mouse, touchpad, tablet, 3D gesture capture device, etc.). In some embodiments, the input device 432 may be used to manually maneuver a portion of the vehicle 100 into a charging position (e.g., moving a charging plate to a desired separation distance, etc.).

While one or more of displays of instrument panel 400 may be touch-screen displays, it should be appreciated that the vehicle operational display may be a display incapable of receiving touch input. For instance, the operational display 420 that spans across an interior space centerline 404 and across both a first zone 408A and a second zone 408B may be isolated from receiving input from touch, especially from a passenger. In some cases, a display that provides vehicle operation or critical systems information and interface may be restricted from receiving touch input and/or be configured as a non-touch display. This type of configuration can prevent dangerous mistakes in providing touch input where such input may cause an accident or unwanted control.

In some embodiments, one or more displays of the instrument panel 400 may be mobile devices and/or applications residing on a mobile device such as a smart phone. Additionally or alternatively, any of the information described herein may be presented to one or more portions 420A-N of the operational display 420 or other display 424, 428, 434. In one embodiment, one or more displays of the instrument panel 400 may be physically separated or detached from the instrument panel 400. In some cases, a detachable display may remain tethered to the instrument panel.

The portions 420A-N of the operational display 420 may be dynamically reconfigured and/or resized to suit any display of information as described. Additionally or alternatively, the number of portions 420A-N used to visually present information via the operational display 420 may be dynamically increased or decreased as required, and are not limited to the configurations shown.

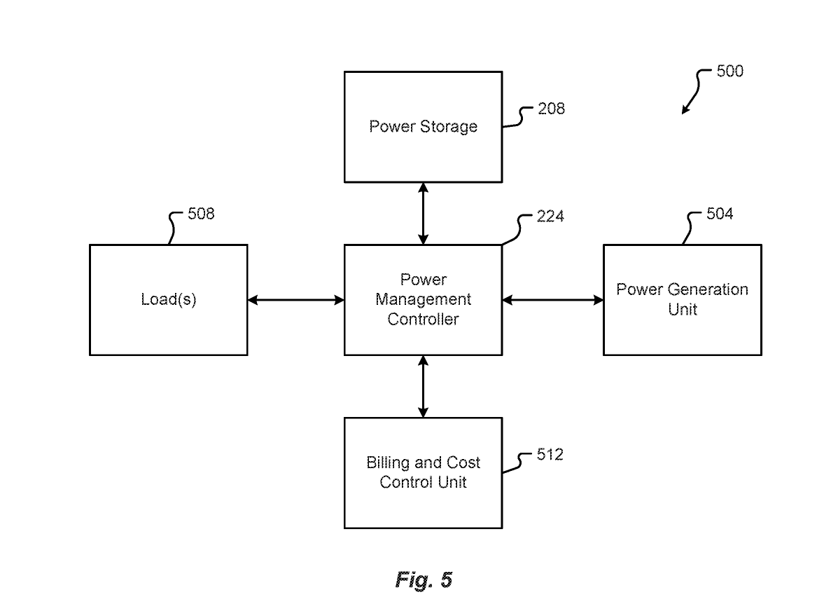

An embodiment of the electrical system 500 associated with the vehicle 100 may be as shown in FIG. 5. The electrical system 500 can include power source(s) that generate power, power storage that stores power, and/or load(s) that consume power. Power sources may be associated with a power generation unit 504. Power storage may be associated with a power storage system 208. Loads may be associated with loads 508. The electrical system 500 may be managed by a power management controller/power electronics unit 224. Further, the electrical system 500 can include one or more other interfaces or controllers, which can include the billing and cost control unit 512.

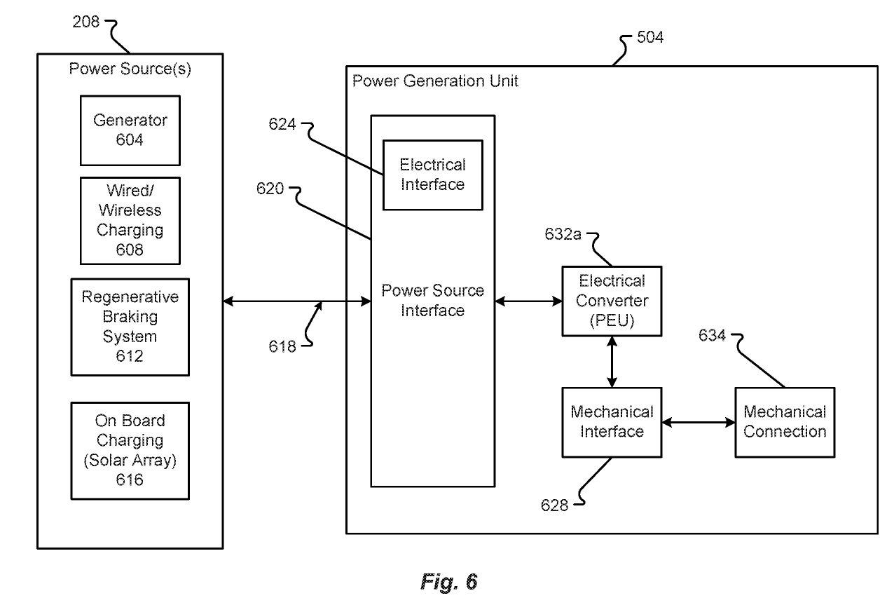

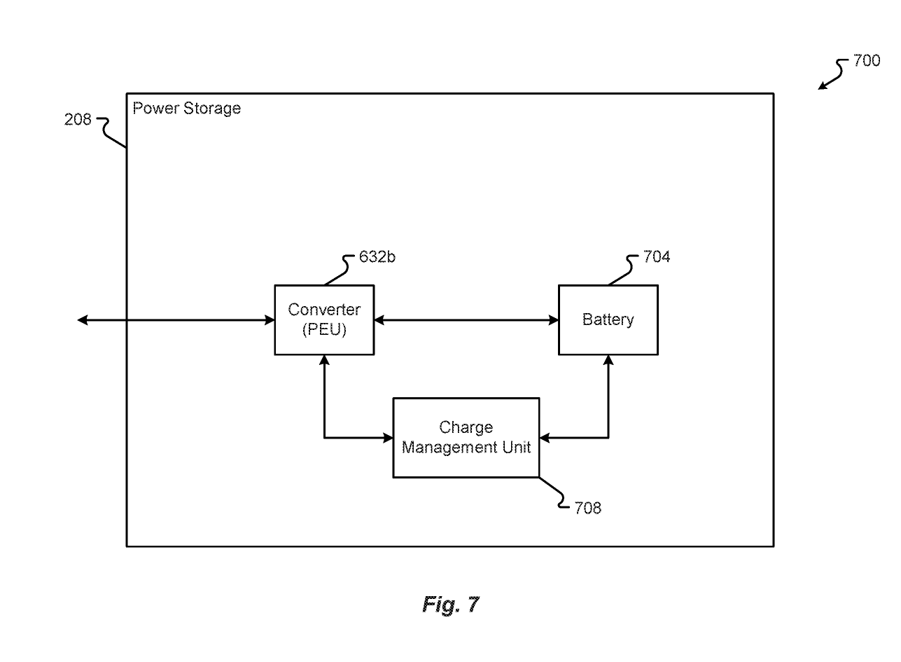

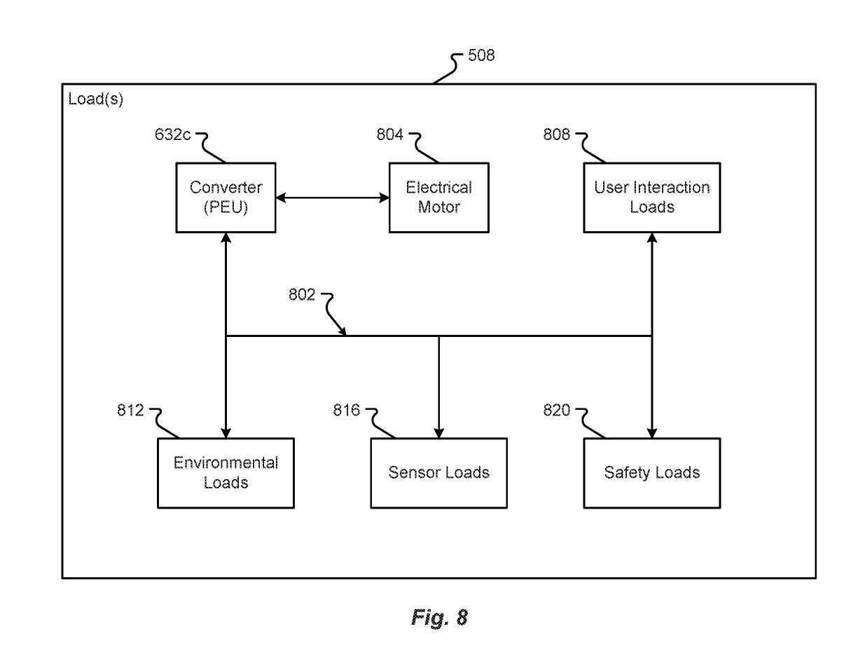

The power generation unit 504 may be as described in conjunction with FIG. 6. The power storage component 208 may be as described in conjunction with FIG. 7. The loads 508 may be as described in conjunction with FIG. 8.

The billing and cost control unit 512 may interface with the power management controller 224 to determine the amount of charge or power provided to the power storage 208 through the power generation unit 504. The billing and cost control unit 512 can then provide information for billing the vehicle owner. Thus, the billing and cost control unit 512 can receive and/or send power information to third party system(s) regarding the received charge from an external source. The information provided can help determine an amount of money required, from the owner of the vehicle, as payment for the provided power. Alternatively, or in addition, if the owner of the vehicle provided power to another vehicle (or another device/system), that owner may be owed compensation for the provided power or energy, e.g., a credit.

The power management controller 224 can be a computer or computing system(s) and/or electrical system with associated components, as described herein, capable of managing the power generation unit 504 to receive power, routing the power to the power storage 208, and then providing the power from either the power generation unit 504 and/or the power storage 208 to the loads 508. Thus, the power management controller 224 may execute programming that controls switches, devices, components, etc. involved in the reception, storage, and provision of the power in the electrical system 500.

An embodiment of the power generation unit 504 may be as shown in FIG. 6. Generally, the power generation unit 504 may be electrically coupled to one or more power sources 208. The power sources 208 can include power sources internal and/or associated with the vehicle 100 and/or power sources external to the vehicle 100 to which the vehicle 100 electrically connects. One of the internal power sources can include an on-board generator 604. The generator 604 may be an alternating current (AC) generator, a direct current (DC) generator or a self-excited generator. The AC generators can include induction generators, linear electric generators, and/or other types of generators. The DC generators can include homopolar generators and/or other types of generators. The generator 604 can be brushless or include brush contacts and generate the electric field with permanent magnets or through induction. The generator 604 may be mechanically coupled to a source of kinetic energy, such as an axle or some other power take-off. The generator 604 may also have another mechanical coupling to an exterior source of kinetic energy, for example, a wind turbine.

Another power source 208 may include wired or wireless charging 608. The wireless charging system 608 may include inductive and/or resonant frequency inductive charging systems that can include coils, frequency generators, controllers, etc. Wired charging may be any kind of grid-connected charging that has a physical connection, although, the wireless charging may be grid connected through a wireless interface. The wired charging system can include connectors, wired interconnections, the controllers, etc. The wired and wireless charging systems 608 can provide power to the power generation unit 504 from external power sources 208.

Internal sources for power may include a regenerative braking system 612. The regenerative braking system 612 can convert the kinetic energy of the moving car into electrical energy through a generation system mounted within the wheels, axle, and/or braking system of the vehicle 100. The regenerative braking system 612 can include any coils, magnets, electrical interconnections, converters, controllers, etc. required to convert the kinetic energy into electrical energy.

Another source of power 208, internal to or associated with the vehicle 100, may be a solar array 616. The solar array 616 may include any system or device of one or more solar cells mounted on the exterior of the vehicle 100 or integrated within the body panels of the vehicle 100 that provides or converts solar energy into electrical energy to provide to the power generation unit 504.

The power sources 208 may be connected to the power generation unit 504 through an electrical interconnection 618. The electrical interconnection 618 can include any wire, interface, bus, etc. between the one or more power sources 208 and the power generation unit 504.

The power generation unit 504 can also include a power source interface 620. The power source interface 620 can be any type of physical and/or electrical interface used to receive the electrical energy from the one or more power sources 208; thus, the power source interface 620 can include an electrical interface 624 that receives the electrical energy and a mechanical interface 628 which may include wires, connectors, or other types of devices or physical connections. The mechanical interface 608 can also include a physical/electrical connection 634 to the power generation unit 504.

The electrical energy from the power source 208 can be processed through the power source interface 624 to an electric converter 632, which may comprise all or a portion of the power electronics associated with the power management controller/power electronics unit (PEU) 224. The electric converter 632 may convert the characteristics of the power from one of the power sources into a useable form that may be used either by the power storage 208 or one or more loads 508 within the vehicle 100. The electrical converter 624 may include any electronics or electrical devices and/or component that can change electrical characteristics, e.g., AC frequency, amplitude, phase, etc. associated with the electrical energy provided by the power source 208. The converted electrical energy may then be provided to an optional conditioner (not shown). The conditioner may include any electronics or electrical devices and/or component that may further condition the converted electrical energy by removing harmonics, noise, etc. from the electrical energy to provide a more stable and effective form of power to the vehicle 100.

An embodiment of the power storage 208 may be as shown in FIG. 7. The power storage unit can include an electrical converter 632b, one or more batteries, one or more rechargeable batteries, one or more capacitors, one or more accumulators, one or more supercapacitors, one or more ultrabatteries, and/or superconducting magnetics 704, and/or a charge management unit 708. The converter 632b may be the same or similar to the electrical converter 632a shown in FIG. 6. The converter 632b may be a replacement for the electric converter 632a shown in FIG. 6 and thus eliminate the need for the electrical converter 632a as shown in FIG. 6. However, if the electrical converter 632a is provided in the power generation unit 504, the converter 632b, as shown in the power storage unit 208, may be eliminated. The converter 632b can also be redundant or different from the electrical converter 632a shown in FIG. 6 and may provide a different form of energy to the battery and/or capacitors 704. Thus, the converter 632b can change the energy characteristics specifically for the battery/capacitor 704.

The battery 704 can be any type of battery for storing electrical energy, for example, a lithium ion battery, a lead acid battery, a nickel cadmium battery, etc. Further, the battery 704 may include different types of power storage systems, such as, ionic fluids or other types of fuel cell systems. The energy storage 704 may also include one or more high-capacity capacitors 704. The capacitors 704 may be used for long-term or short-term storage of electrical energy. The input into the battery or capacitor 704 may be different from the output, and thus, the capacitor 704 may be charged quickly but drain slowly. The functioning of the converter 632 and battery capacitor 704 may be monitored or managed by a charge management unit 708.

The charge management unit 708 can include any hardware (e.g., any electronics or electrical devices and/or components), software, or firmware operable to adjust the operations of the converter 632 or batteries/capacitors 704. The charge management unit 708 can receive inputs or periodically monitor the converter 632 and/or battery/capacitor 704 from this information; the charge management unit 708 may then adjust settings or inputs into the converter 632 or battery/capacitor 704 to control the operation of the power storage system 208.

An embodiment of one or more loads 508 associated with the vehicle 100 may be as shown in FIG. 8. The loads 508 may include a bus or electrical interconnection system 802, which provides electrical energy to one or more different loads within the vehicle 100. The bus 802 can be any number of wires or interfaces used to connect the power generation unit 504 and/or power storage 208 to the one or more loads 508. The converter (PEU) 632c may be an interface from the power generation unit 504 or the power storage 208 into the loads 508. The converter (PEU) 632c may be the same or similar to electric converter (PEU) 632a as shown in FIG. 6. Similar to the discussion of the converter (PEU) 632b in FIG. 7, the converter (PEU) 632c may be eliminated, if the electric converter (PEU) 632a, shown in FIG. 6, is present. However, the converter (PEU) 632c may further condition or change the energy characteristics for the bus 802 for use by the loads 508. The converter (PEU) 632c may also provide electrical energy to electric motor 804, which may power the vehicle 100.

The electric motor 804 can be any type of DC or AC electric motor. The electric motor may be a direct drive or induction motor using permanent magnets and/or winding either on the stator or rotor. The electric motor 804 may also be wireless or include brush contacts. The electric motor 804 may be capable of providing a torque and enough kinetic energy to move the vehicle 100 in traffic. In some embodiments, the electric motor 804 may be similar, if not identical, to the electric motor 212 described in conjunction with FIG. 2.

The different loads 508 may also include environmental loads 812, sensor loads 816, safety loads 820, user interaction loads 808, etc. User interaction loads 808 can be any energy used by user interfaces or systems that interact with the driver and/or passenger(s) of the vehicle 100. These loads 808 may include, for example, the heads up display 434, the dash display 420, 424, 428, the radio, user interfaces on the head unit, lights, radio, and/or other types of loads that provide or receive information from the occupants of the vehicle 100. The environmental loads 812 can be any loads used to control the environment within the vehicle 100. For example, the air conditioning or heating unit of the vehicle 100 can be environmental loads 812. Other environmental loads can include lights, fans, and/or defrosting units, etc. that may control the environment within, and/or outside of, the vehicle 100. The sensor loads 816 can be any loads used by sensors, for example, air bag sensors, GPS, and other such sensors used to either manage or control the vehicle 100 and/or provide information or feedback to the vehicle occupants. The safety loads 820 can include any safety equipment, for example, seat belt alarms, airbags, headlights, blinkers, etc. that may be used to manage the safety of the occupants of the vehicle 100. There may be more or fewer loads than those described herein, although they may not be shown in FIG. 8.

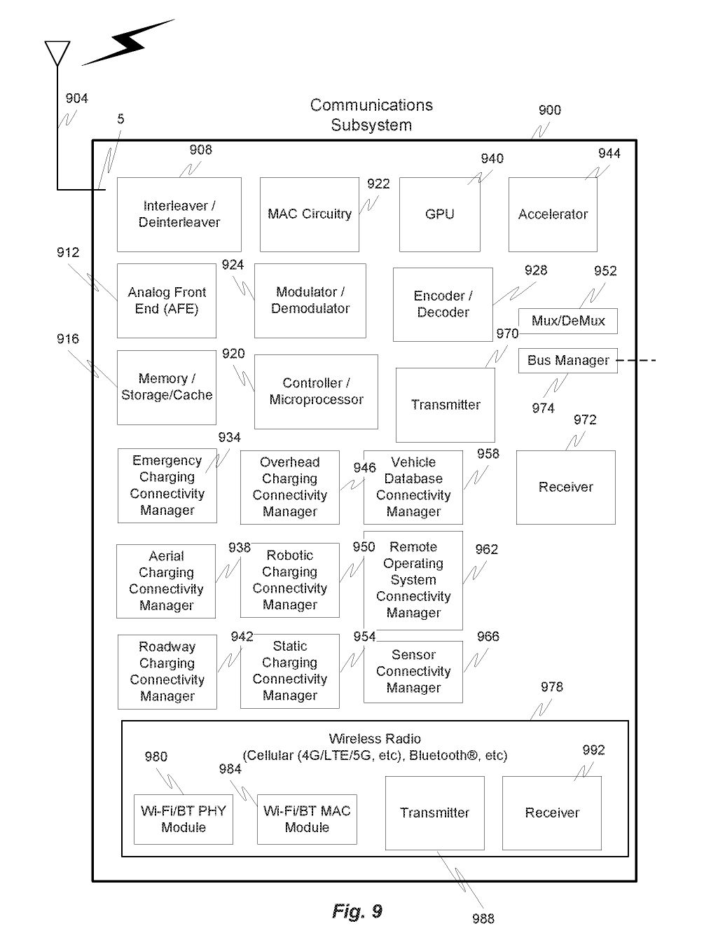

FIG. 9 illustrates a hardware diagram of communications componentry that can be optionally associated with the vehicle 100 in accordance with embodiments of the present disclosure.

The communications componentry can include one or more wired or wireless devices such as a transceiver(s) and/or modem that allows communications not only between the various systems disclosed herein but also with other devices, such as devices on a network, and/or on a distributed network such as the Internet and/or in the cloud and/or with other vehicle(s).

The communications subsystem can also include inter- and intra-vehicle communications capabilities such as hotspot and/or access point connectivity for any one or more of the vehicle occupants and/or vehicle-to-vehicle communications.

Additionally, and while not specifically illustrated, the communications subsystem can include one or more communications links (that can be wired or wireless) and/or communications busses (managed by the bus manager 974), including one or more of CANbus, OBD-II, ARCINC 429, Byteflight, CAN (Controller Area Network), D2B (Domestic Digital Bus), FlexRay, DC-BUS, IDB-1394, IEBus, I2C, ISO 9141-1/-2, J1708, J1587, J1850, J1939, ISO 11783, Keyword Protocol 2000, LIN (Local Interconnect Network), MOST (Media Oriented Systems Transport), Multifunction Vehicle Bus, SMARTwireX, SPI, VAN (Vehicle Area Network), and the like or in general any communications protocol and/or standard(s).

The various protocols and communications can be communicated one or more of wirelessly and/or over transmission media such as single wire, twisted pair, fiber optic, IEEE 1394, MIL-STD-1553, MIL-STD-1773, power-line communication, or the like. (All of the above standards and protocols are incorporated herein by reference in their entirety).

As discussed, the communications subsystem enables communications between any if the inter-vehicle systems and subsystems as well as communications with non-collocated resources, such as those reachable over a network such as the Internet.

The communications subsystem 900, in addition to well-known componentry (which has been omitted for clarity), includes interconnected elements including one or more of: one or more antennas 904, an interleaver/deinterleaver 908, an analog front end (AFE) 912, memory/storage/cache 916, controller/microprocessor 920, MAC circuitry 922, modulator/demodulator 924, encoder/decoder 928, a plurality of connectivity managers 934-966, GPU 940, accelerator 944, a multiplexer/demultiplexer 952, transmitter 970, receiver 972 and wireless radio 978 components such as a Wi-Fi PHY/Bluetooth® module 980, a Wi-Fi/BT MAC module 984, transmitter 988 and receiver 992. The various elements in the device 900 are connected by one or more links/busses 5 (not shown, again for sake of clarity).

The device 400 can have one more antennas 904, for use in wireless communications such as multi-input multi-output (MIMO) communications, multi-user multi-input multi-output (MU-MIMO) communications Bluetooth®, LTE, 4G, 5G, Near-Field Communication (NFC), etc., and in general for any type of wireless communications. The antenna(s) 904 can include, but are not limited to one or more of directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users for example within the vehicle 100 and/or in another vehicle.

Antenna(s) 904 generally interact with the Analog Front End (AFE) 912, which is needed to enable the correct processing of the received modulated signal and signal conditioning for a transmitted signal. The AFE 912 can be functionally located between the antenna and a digital baseband system to convert the analog signal into a digital signal for processing and vice-versa.

The subsystem 900 can also include a controller/microprocessor 920 and a memory/storage/cache 916. The subsystem 900 can interact with the memory/storage/cache 916 which may store information and operations necessary for configuring and transmitting or receiving the information described herein. The memory/storage/cache 916 may also be used in connection with the execution of application programming or instructions by the controller/microprocessor 920, and for temporary or long term storage of program instructions and/or data. As examples, the memory/storage/cache 920 may comprise a computer-readable device, RAM, ROM, DRAM, SDRAM, and/or other storage device(s) and media.

The controller/microprocessor 920 may comprise a general purpose programmable processor or controller for executing application programming or instructions related to the subsystem 900. Furthermore, the controller/microprocessor 920 can perform operations for configuring and transmitting/receiving information as described herein. The controller/microprocessor 920 may include multiple processor cores, and/or implement multiple virtual processors. Optionally, the controller/microprocessor 920 may include multiple physical processors. By way of example, the controller/microprocessor 920 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The subsystem 900 can further include a transmitter 970 and receiver 972 which can transmit and receive signals, respectively, to and from other devices, subsystems and/or other destinations using the one or more antennas 904 and/or links/busses. Included in the subsystem 900 circuitry is the medium access control or MAC Circuitry 922. MAC circuitry 922 provides for controlling access to the wireless medium. In an exemplary embodiment, the MAC circuitry 922 may be arranged to contend for the wireless medium and configure frames or packets for communicating over the wired/wireless medium.

The subsystem 900 can also optionally contain a security module (not shown). This security module can contain information regarding but not limited to, security parameters required to connect the device to one or more other devices or other available network(s), and can include WEP or WPA/WPA-2 (optionally+AES and/or TKIP) security access keys, network keys, etc. The WEP security access key is a security password used by Wi-Fi networks. Knowledge of this code can enable a wireless device to exchange information with an access point and/or another device. The information exchange can occur through encoded messages with the WEP access code often being chosen by the network administrator. WPA is an added security standard that is also used in conjunction with network connectivity with stronger encryption than WEP.

In some embodiments, the communications subsystem 900 also includes a GPU 940, an accelerator 944, a Wi-Fi/BT/BLE PHY module 980 and a Wi-Fi/BT/BLE MAC module 984 and wireless transmitter 988 and receiver 992. In some embodiments, the GPU 940 may be a graphics processing unit, or visual processing unit, comprising at least one circuit and/or chip that manipulates and changes memory to accelerate the creation of images in a frame buffer for output to at least one display device. The GPU 940 may include one or more of a display device connection port, printed circuit board (PCB), a GPU chip, a metal-oxide-semiconductor field-effect transistor (MOSFET), memory (e.g., single data rate random-access memory (SDRAM), double data rate random-access memory (DDR) RAM, etc., and/or combinations thereof), a secondary processing chip (e.g., handling video out capabilities, processing, and/or other functions in addition to the GPU chip, etc.), a capacitor, heatsink, temperature control or cooling fan, motherboard connection, shielding, and the like.

The various connectivity managers 934-966 (even) manage and/or coordinate communications between the subsystem 900 and one or more of the systems disclosed herein and one or more other devices/systems. The connectivity managers include an emergency charging connectivity manager 934, an aerial charging connectivity manager 938, a roadway charging connectivity manager 942, an overhead charging connectivity manager 946, a robotic charging connectivity manager 950, a static charging connectivity manager 954, a vehicle database connectivity manager 958, a remote operating system connectivity manager 962 and a sensor connectivity manager 966.

The emergency charging connectivity manager 934 can coordinate not only the physical connectivity between the vehicle 100 and the emergency charging device/vehicle, but can also communicate with one or more of the power management controller, one or more third parties and optionally a billing system(s). As an example, the vehicle 100 can establish communications with the emergency charging device/vehicle to one or more of coordinate interconnectivity between the two (e.g., by spatially aligning the charging receptacle on the vehicle with the charger on the emergency charging vehicle) and optionally share navigation information. Once charging is complete, the amount of charge provided can be tracked and optionally forwarded to, for example, a third party for billing. In addition to being able to manage connectivity for the exchange of power, the emergency charging connectivity manager 934 can also communicate information, such as billing information to the emergency charging vehicle and/or a third party. This billing information could be, for example, the owner of the vehicle, the driver/occupant(s) of the vehicle, company information, or in general any information usable to charge the appropriate entity for the power received.

The aerial charging connectivity manager 938 can coordinate not only the physical connectivity between the vehicle 100 and the aerial charging device/vehicle, but can also communicate with one or more of the power management controller, one or more third parties and optionally a billing system(s). As an example, the vehicle 100 can establish communications with the aerial charging device/vehicle to one or more of coordinate interconnectivity between the two (e.g., by spatially aligning the charging receptacle on the vehicle with the charger on the emergency charging vehicle) and optionally share navigation information. Once charging is complete, the amount of charge provided can be tracked and optionally forwarded to, for example, a third party for billing. In addition to being able to manage connectivity for the exchange of power, the aerial charging connectivity manager 938 can similarly communicate information, such as billing information to the aerial charging vehicle and/or a third party. This billing information could be, for example, the owner of the vehicle 100, the driver/occupant(s) of the vehicle 100, company information, or in general any information usable to charge the appropriate entity for the power received etc., as discussed.

The roadway charging connectivity manager 942 and overhead charging connectivity manager 946 can coordinate not only the physical connectivity between the vehicle 100 and the charging device/system, but can also communicate with one or more of the power management controller, one or more third parties and optionally a billing system(s). As one example, the vehicle 100 can request a charge from the charging system when, for example, the vehicle 100 needs or is predicted to need power. As an example, the vehicle 100 can establish communications with the charging device/vehicle to one or more of coordinate interconnectivity between the two for charging and share information for billing. Once charging is complete, the amount of charge provided can be tracked and optionally forwarded to, for example, a third party for billing. This billing information could be, for example, the owner of the vehicle 100, the driver/occupant(s) of the vehicle 100, company information, or in general any information usable to charge the appropriate entity for the power received etc., as discussed. The person responsible for paying for the charge could also receive a copy of the billing information as is customary. The robotic charging connectivity manager 950 and static charging connectivity manager 954 can operate in a similar manner to that described herein.

The vehicle database connectivity manager 958 allows the subsystem to receive and/or share information stored in the vehicle database. This information can be shared with other vehicle components/subsystems and/or other entities, such as third parties and/or charging systems. The information can also be shared with one or more vehicle occupant devices, such as an app (application) on a mobile device the driver uses to track information about the vehicle 100 and/or a dealer or service/maintenance provider. In general, any information stored in the vehicle database can optionally be shared with any one or more other devices optionally subject to any privacy or confidentially restrictions.

The remote operating system connectivity manager 962 facilitates communications between the vehicle 100 and any one or more autonomous vehicle systems. These communications can include one or more of navigation information, vehicle information, other vehicle information, weather information, occupant information, or in general any information related to the remote operation of the vehicle 100.

The sensor connectivity manager 966 facilitates communications between any one or more of the vehicle sensors and any one or more of the other vehicle systems. The sensor connectivity manager 966 can also facilitate communications between any one or more of the sensors and/or vehicle systems and any other destination, such as a service company, app, or in general to any destination where sensor data is needed.

In accordance with one exemplary embodiment, any of the communications discussed herein can be communicated via the conductor(s) used for charging. One exemplary protocol usable for these communications is Power-line communication (PLC). PLC is a communication protocol that uses electrical wiring to simultaneously carry both data, and Alternating Current (AC) electric power transmission or electric power distribution. It is also known as power-line carrier, power-line digital subscriber line (PDSL), mains communication, power-line telecommunications, or power-line networking (PLN). For DC environments in vehicles PLC can be used in conjunction with CAN-bus, LIN-bus over power line (DC-LIN) and DC-BUS.

The communications subsystem can also optionally manage one or more identifiers, such as an IP (internet protocol) address(es), associated with the vehicle and one or other system or subsystems or components therein. These identifiers can be used in conjunction with any one or more of the connectivity managers as discussed herein.

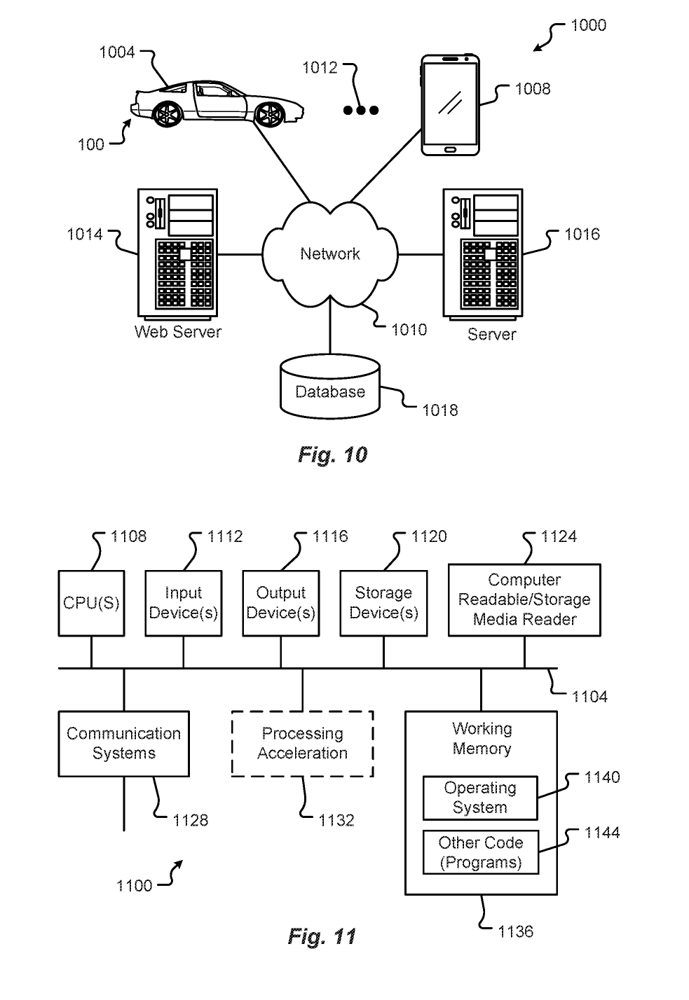

FIG. 10 illustrates a block diagram of a computing environment 1000 that may function as the servers, user computers, or other systems provided and described herein. The environment 1000 includes one or more user computers, or computing devices, such as a vehicle computing device 1004, a communication device 1008, and/or more 1012. The computing devices 1004, 1008, 1012 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 1004, 1008, 1012 may also have any of a variety of applications, including for example, database client and/or server applications, and web browser applications. Alternatively, the computing devices 1004, 1008, 1012 may be any other electronic device, such as a thin-client computer, Internet-enabled mobile telephone, and/or personal digital assistant, capable of communicating via a network 1010 and/or displaying and navigating web pages or other types of electronic documents. Although the exemplary computer environment 1000 is shown with two computing devices, any number of user computers or computing devices may be supported.

Environment 1000 further includes a network 1010. The network 1010 may can be any type of network familiar to those skilled in the art that can support data communications using any of a variety of commercially-available protocols, including without limitation SIP, TCP/IP, SNA, IPX, AppleTalk, and the like. Merely by way of example, the network 1010 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 1014, 1016. In this example, server 1014 is shown as a web server and server 1016 is shown as an application server. The web server 1014, which may be used to process requests for web pages or other electronic documents from computing devices 1004, 1008, 1012. The web server 1014 can be running an operating system including any of those discussed above, as well as any commercially-available server operating systems. The web server 1014 can also run a variety of server applications, including SIP (Session Initiation Protocol) servers, HTTP(s) servers, FTP servers, CGI servers, database servers, Java servers, and the like. In some instances, the web server 1014 may publish operations available operations as one or more web services.

The environment 1000 may also include one or more file and or/application servers 1016, which can, in addition to an operating system, include one or more applications accessible by a client running on one or more of the computing devices 1004, 1008, 1012. The server(s) 1016 and/or 1014 may be one or more general purpose computers capable of executing programs or scripts in response to the computing devices 1004, 1008, 1012. As one example, the server 1016, 1014 may execute one or more web applications. The web application may be implemented as one or more scripts or programs written in any programming language, such as Java™, C, C#®, or C++, and/or any scripting language, such as Perl, Python, or TCL, as well as combinations of any programming/scripting languages. The application server(s) 1016 may also include database servers, including without limitation those commercially available from Oracle®, Microsoft®, Sybase®, IBM® and the like, which can process requests from database clients running on a computing device 1004, 1008, 1012.

The web pages created by the server 1014 and/or 1016 may be forwarded to a computing device 1004, 1008, 1012 via a web (file) server 1014, 1016. Similarly, the web server 1014 may be able to receive web page requests, web services invocations, and/or input data from a computing device 1004, 1008, 1012 (e.g., a user computer, etc.) and can forward the web page requests and/or input data to the web (application) server 1016. In further embodiments, the server 1016 may function as a file server. Although for ease of description, FIG. 10 illustrates a separate web server 1014 and file/application server 1016, those skilled in the art will recognize that the functions described with respect to servers 1014, 1016 may be performed by a single server and/or a plurality of specialized servers, depending on implementation-specific needs and parameters. The computer systems 1004, 1008, 1012, web (file) server 1014 and/or web (application) server 1016 may function as the system, devices, or components described in FIGS. 1-10.

The environment 1000 may also include a database 1018. The database 1018 may reside in a variety of locations. By way of example, database 1018 may reside on a storage medium local to (and/or resident in) one or more of the computers 1004, 1008, 1012, 1014, 1016. Alternatively, it may be remote from any or all of the computers 1004, 1008, 1012, 1014, 1016, and in communication (e.g., via the network 1010) with one or more of these. The database 1018 may reside in a storage-area network (“SAN”) familiar to those skilled in the art. Similarly, any necessary files for performing the functions attributed to the computers 1004, 1008, 1012, 1014, 1016 may be stored locally on the respective computer and/or remotely, as appropriate. The database 1018 may be a relational database, such as Oracle 20i®, that is adapted to store, update, and retrieve data in response to SQL-formatted commands.

FIG. 11 illustrates one embodiment of a computer system 1100 upon which the servers, user computers, computing devices, or other systems or components described above may be deployed or executed. The computer system 1100 is shown comprising hardware elements that may be electrically coupled via a bus 1104. The hardware elements may include one or more central processing units (CPUs) 1108, also referred to as a processor(s); one or more input devices 1112 (e.g., a mouse, a keyboard, etc.); and one or more output devices 1116 (e.g., a display device, a printer, etc.). The computer system 1100 may also include one or more storage devices 1120. By way of example, storage device(s) 1120 may be disk drives, optical storage devices, solid-state storage devices such as a random access memory (“RAM”) and/or a read-only memory (“ROM”), which can be programmable, flash-updateable and/or the like.

The computer system 1100 may additionally include a computer-readable storage media reader 1124; a communications system 1128 (e.g., a modem, a network card (wireless or wired), an infra-red communication device, etc.); and working memory 1136, which may include RAM and ROM devices as described above. The computer system 1100 may also include a processing acceleration unit 1132, which can include a DSP, a special-purpose processor, and/or the like.

The computer-readable storage media reader 1124 can further be connected to a computer-readable storage medium, together (and, optionally, in combination with storage device(s) 1120) comprehensively representing remote, local, fixed, and/or removable storage devices plus storage media for temporarily and/or more permanently containing computer-readable information. The communications system 1128 may permit data to be exchanged with a network and/or any other computer described above with respect to the computer environments described herein. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 1100 may also comprise software elements, shown as being currently located within a working memory 1136, including an operating system 1140 and/or other code 1144. It should be appreciated that alternate embodiments of a computer system 1100 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 1108 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

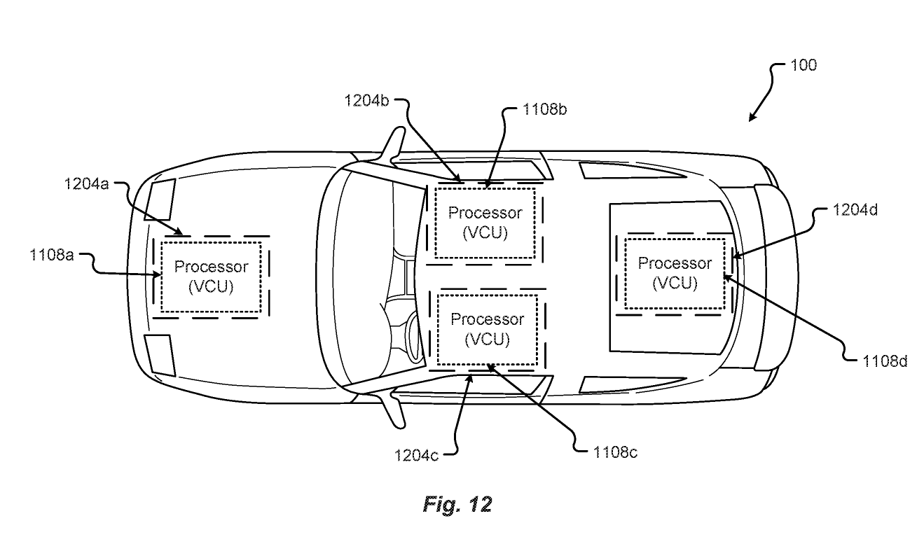

Another embodiment of the vehicle 100 having two or more redundant vehicle control systems 1204 may be as shown in FIG. 12. The vehicle control systems, 1204a through 1204d, may be located in different locations within the vehicle 100. These redundant control systems 1204 may include the components used to control the electrical driving functions and/or other functions of the vehicle 100. For example, each vehicle control system 1204 may include a processor 1108, as previously described in conjunction FIG. 11, that executes a vehicle control unit VCU).

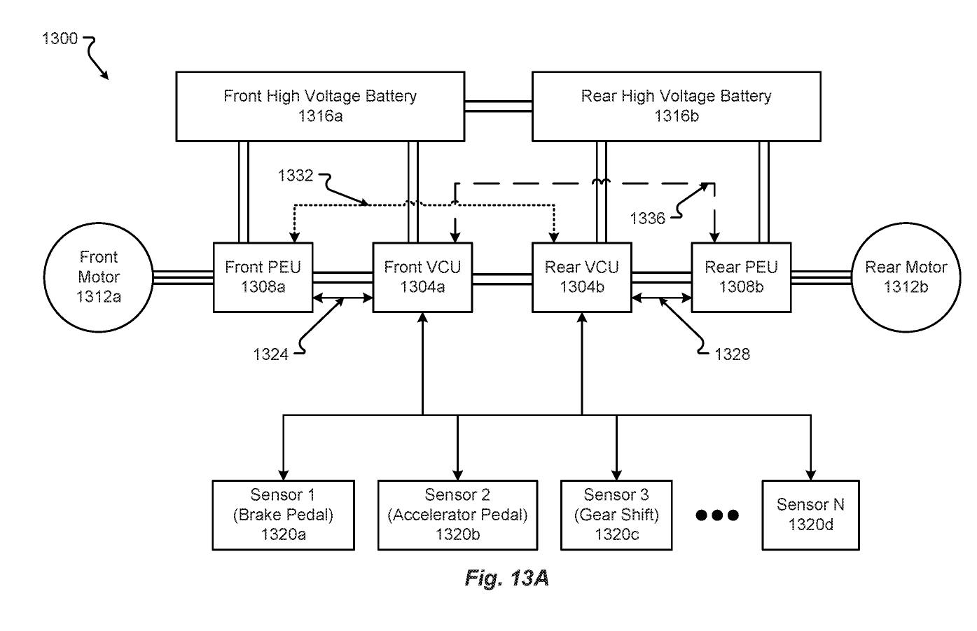

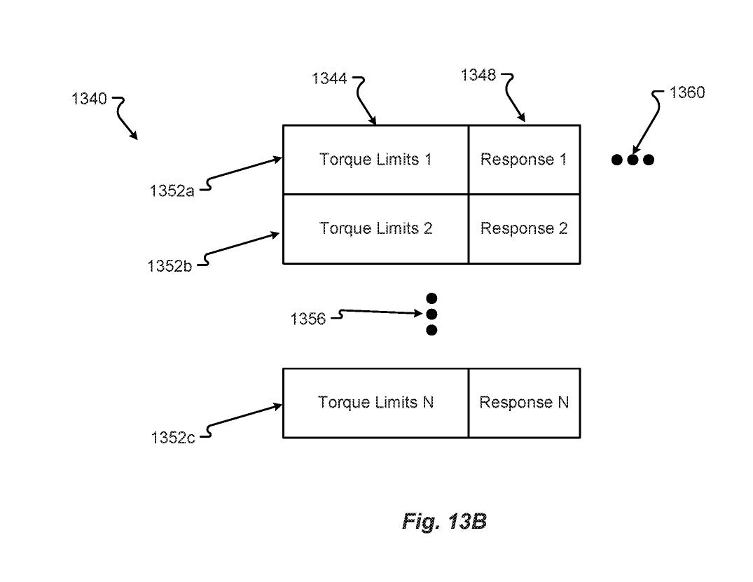

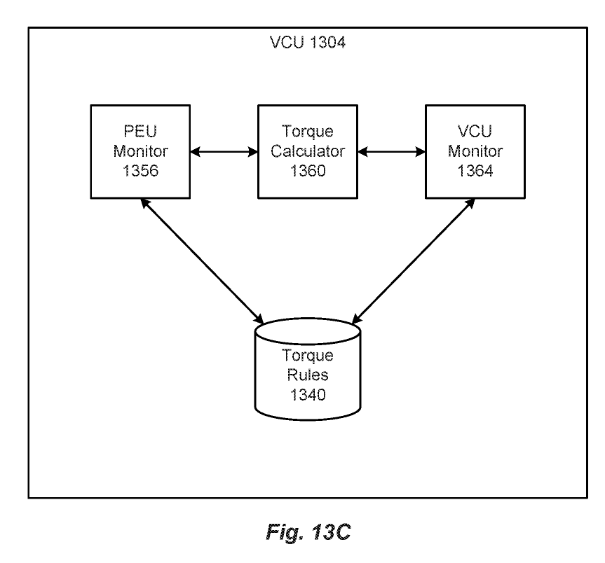

While the vehicle control system 1204 can include separate hardware components that may function as a VCU, a power electronics unit (PEU), etc., as described in conjunction with FIG. 13. However, as will be described hereinafter, the VCU and one or more other functions of the vehicle control system 1204 may be executed as software in the processor 1108. It should be noted that the functions of the vehicle control system 1204 may be performed completely by hardware, completely by hardware, or by a combination of hardware and software.

In the embodiment shown in FIG. 12, the vehicle control system 1204 includes four processors 1108 executing the VCU and other functions, but the vehicle 100 can include any number of two or more processors 1108 or vehicle control systems 1204. By placing the vehicle control systems in different locations in the vehicle 100, the vehicle control systems 1204 may maintain control of the vehicle 100 during failures, accidents, or other anomalies.

An embodiment of one or more components that may compose a vehicle control system 1204 may be shown in FIG. 13A. The vehicle control system 1204 may include some or all of the componentry 1300, which can include one or more of, but is not limited to, a front or first VCU 1304a, a rear or second VCU 1304b, a front or first PEU 1308a, a second or rear PEU 1308b, a first or front motor 1312a, a second or rear motor 1312b a first or front high voltage battery 1316a, a second or rear high-voltage battery 1316b, and one or more sensors 1320.

Each of the sensors 1320 may be in communication with each of the front VCU 1304a and the second VCU 1304b. The sensors 1320 may obtain information and/or send and/or receive signals from one or more vehicle systems, for example, the brake pedal or braking system 1320a, the accelerator pedal or acceleration system 1320b, a gearshift or transmission system 1320c, a vehicle stability control system, a traction control system, or other functions or systems of the vehicle 100 to control the driving characteristics of the vehicle 100.

The VCU 1304 executed by the processing component may control the functions of the vehicle 100. The VCU 1304 can receive the sensor information from the sensor(s) 1320 and determine the operation required by the motor 1312 (e.g., speed, acceleration, deceleration, etc.). Such operation of the motor 1312 can include the amount of torque to be applied by the motor 1312 to the wheels 220. Thus, the front and rear VCU 1304a, 1304b may determine an amount of torque based on calculations derived from data from the different sensors 1320 and provide that information to the power electronics unit 1308a, 1308b. The power electronics unit 1308 can convert the direct current (DC) electrical power signal from first and/or second the voltage battery 1316a, 1316b into a three-phase alternating current (AC) electrical signals sent to the motor 1312. Thus, the VCU 1304 controls the operation of the motor 1312 through the signaling of the PEU 1308.

The PEU 1308 can include any of the components, for example, filters, AC/DC converters, etc., used to convert the DC signal from the batteries 1316a, 1316b to an AC signal sent to the motor 1312. The PEU 1308 can be hardware, software, or a combination of hardware and software. The PEU 1308 may be controlled by the VCU 1304 through a series of commands sent from the VCU to the PEU 1308. For safety situations, the VCU 1308 can receive information back from the PEU 1308 regarding the function of the motor 1312. For example, the PEU 1308 may send the amount of torque, being applied by the motor 1312, to the VCU 1304. The commands and information sent to and from the PEU 1308a, 1308b may be exchanged over signal path 1324, 1328.

The VCU 1304 may compare the sensed or estimated torque received from the PEU 1308 with a calculated torque desired by the VCU 1304. This comparison may determine whether the motor 1312a, 1312b is operating properly and/or in adherence to the command sent by the VCU 1304 to the PEU 1308. If the sensed or estimated torque and calculated torque do not compare, that is, the sensed or estimated torque and calculated torque are not the same or similar, the VCU 1304 may conduct actions or responses to ensure that the motor 1312 operates within acceptable tolerances. For example, the VCU 1304 can command the PEU 1308 to change the amount of torque required by the motor 1312. The VCU 1304 may also cease operation of the PEU 1308 or the motor 1312 if the deviation of the sensed or estimated torque and calculated torque is great enough or crosses a predetermined threshold. Regardless, the VCU 1304 can conduct operations and ensure the safe operation of the motor 1312 based on torque rules, which may be as explained in conjunction with FIG. 13B.

Uniquely, the vehicle control system 1300 can include two or more VCUs 1304a, 13 04b. Each VCU 1304a, 1304b can also communicate with both PEUs 1308a and/or 1308b. Thus, the first VCU 1304a can receive the amount of sensed or estimated torque, generated by the second motor 1312b, from the rear PEU 1308b. Based on a comparison of the torque calculated by the first VCU 1304a compared to the actual sensed or estimated torque received from the second PEU 1308b, the first VCU 1304a can determine if the rear VCU 1304b is operating properly. Further, the first VCU 1304a may receive a calculated torque from the second VCU 1304b. By comparing the calculated torque received from the second VCU 1304b to a torque value calculated by the first VCU 1304a, the first VCU 1304a can determine if the second VCU 1304b is properly functioning.

The second or rear VCU 1304b may also similarly function to the first VCU 1304a and make similar torque calculations and comparisons of the first PEU 1308a and first VCU 1304a. Based on the configuration of the vehicle control system 1300 having redundant VCUs 1304a, 1304b, the vehicle control system 1300 provides redundant control of the motor functions and can ensure that an error with one or more of the VCUs 1304a or 1304b may not create a hazardous situation for the vehicle 100 that would be problematic if the VCU 1304 was a single point of failure for the vehicle 100.

An embodiment of a data store 1340, which may store one or more torque rules, may be as shown in FIG. 13B. The torque rules 1340 can include one or more data fields, including but not limited to, a torque limits field 1344 and/or a response field 1348. There may be more or fewer fields for each torque rule as represented by ellipses 1360. A torque limit 1344 can include a threshold, which may be an amount of torque or a difference between two compared torques.

The torque limit 1344 can create a pair of values or a threshold value at which the associated response 1348 is applied. For example, the torque limit 1344 in torque rule 1352a may include a torque difference (between the two compared torques) of 50 Nm, which, if the compared torque is greater than, requires a response 1348 provided in torque rule 1352a. The response 1348 can require various actions by the VCU 1304. For example, the VCU 1304 may re-send the request for the sensed or estimated torque to the PEU 1308. There may be one or more torque rules 1352a, 1352b, and/or 1352c. Thus, there may be more or fewer torque rules 1352 than those shown in FIG. 13B, as represented by ellipses 1356. The torque rules 1352 can include, for example, a command 1348 to the opposite PEU 1308 or VCU 1304 resend a command, a command to the opposite VCU 1304 to recalculate the required torque, commands to shut down or cease operation of the PEU 1308, the VCU 1304, the motor 1312, and/or the battery 1316, or other commands. There may be various other responses capable of being enacted by the VCU 1304 which may be as explained herein.

An embodiment of software components that may be executed by the VCU 1304 may be as shown in FIG. 13C. It should be noted that the functions that are described hereinafter may be embodied in a specially-designed processor or in hardware components. Regardless, the components of the VCU 1304 can include one or more of, but is not limited to, a PEU monitor 1356, a torque calculator 1360, a VCU monitor 1364, and/or the torque rules data store 1304. The torque rules data store 1304 may be stored in memory 1136 and may be as described above.

The PEU monitor 1356 can receive signals from or send commands to the PEU 1308a, 1308b over signal path(s) 1324, 1328. The signals can include the torque that the PEU 1308 has commanded or configured for the motor 1312, the torque being applied by the motor 1312, or other sensed or determined torque information. The PEU monitor 1356 may also command the PEU 1308 based on responses or actions required by the torque rules 1340. For example, the PEU monitor 1356 can instruct the PEU 1308 and/or motor 1312 to cease operation or shut down.

Similarly, the VCU monitor 1364 can receive signals from or send commands to the opposite, e.g., VCU 1304b. The signals received by the VCU monitor 1364 can include the torque that the opposite VCU 1304b has commanded of the motor other 1312b, the torque being applied by the other motor 1312b, or other sensed or determined torque information from the opposite VCU 1304b. The VCU monitor 1364 may also command the opposite VCU 1304b based on responses or actions required by the torque rules 1340. For example, the VCU monitor 1364 can instruct the VCU monitor 1364 to cease operation or shut down.

The torque calculator 1360 can calculate the required torque for the first PEU 1308a and/or second PEU 1308b. The calculated torque can then be supplied, by the torque calculator 1360, to the PEU monitor 1356 and/or VCU monitor 1364. Thus, the torque calculator 1360 can receive the sensor data from sensors 1320 to calculate the torque required by the opposite VCU 1304b, the PEU 1308, etc. These torque values ensure that the various components in the system 1300 are functioning properly.

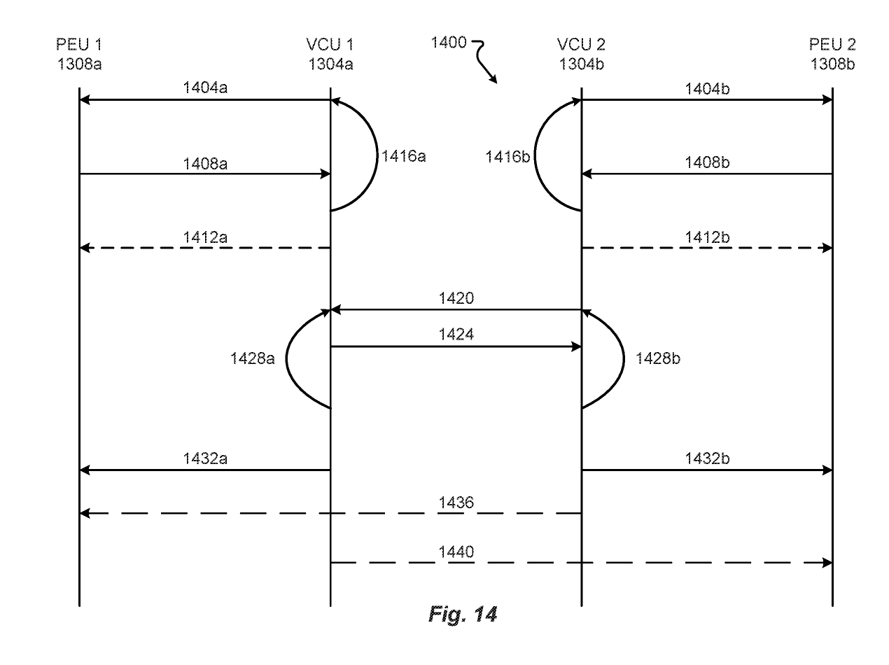

An embodiment of a signaling diagram 1400 internal to the vehicle control system 1300 may be as shown in FIG. 14. The signaling 1400 shown in FIG. 14 may be between a first VCU, e.g., VCU 1304a, and a second VCU, e.g., VCU 1304b, a first PEU, e.g., PEU 1308a, and/or a second PEU, e.g., PEU 1308b. A first signal 1404a, 1404b may be a command from the VCU 1304a, 1304b to the PEU 1308a, 1308b to have the motor 1312a, 1312b apply a torque. The PEU monitor 1356 of the VCU 1304a, 1304b may receive a measurement of the sensed or estimated torque from the PEU 1308a, 1308b in signal 1408a, 1408b. The sensed or estimated torque signal 1408a, 1408b may be a measurement of the sensed or estimated torque, received at the PEU 1308a, 1308b from the motor 1312a, 1312b.

The PEU monitor 1356 of the VCU 1304a, 1304b may then make a comparison of the requested torque and the sensed or estimated torque in signal 1404. If the torque value received in signal 1408 is within accepted tolerances, the PEU monitor 1356 of the VCU 1304a, 1304b may allow the PEU 1308a, 1308b to continue to operate the motor 1312a, 1312b. In contrast, if the sensed or estimated torque in signal 1404 is not within accepted tolerances, the PEU monitor 1356 of the VCU 1304a, 1304b can discontinue operation of the PEU 1308a, 1308b.

If the PEU 1308a, 1308b continues to operate, the VCU 1304a, 1304b can continue to receive sensor signals and evaluate any changes in the context of the driving situation, as measured by a change in the sensors 1320 or some other change in conditions. If the conditions change, the torque calculator 1360 of the VCU 1304a, 1304b may recalculate the required torque, send signal 1416a, 1416b, and have the PEU monitor 1356 resend the signal 1404a, 1404b.

In other situations, if the PEU monitor 1356 determines that the torque received in signal 1408a, 1408b does not compare come to the calculated torque determined by the torque calculator 1360, the PEU monitor 1356 of the VCU 1304a, 1304b may retrieve a torque rule 1352. The PEU monitor 1356 can compare the difference in torque to a torque limit 1344 and read a response 1348 associated with the applicable torque limit 1344. The response can require the PEU monitor 1356 to send another signal 1412a, 1412b. The signal 1412 can request the PEU 1308 resend the sensed or estimated torque, can command the PEU 1308 to change the amount of sensed or estimated torque, can command the PEU 1308 to cease operation or shut down the motor 1312, etc.

Contemporary with the VCU 1304a, 1304b controlling the associated motor 1312a, 1312b, the VCUs 1304a, 1304b can also send a signal to the opposite VCU 1304a, 1304b, in signals 1420 and/or 1424. Thus, each VCU 1304a, 1304b can crosscheck the other VCU 1304a, 1304b to ensure that the other VCU 1304a, 1304b is calculating and applying the desired amount of torque to the opposite motor 1312a, 1312b.

Each VCU 1304a, 1304b can iteratively make calculations or checks of the other VCU 1304a, 1304b. as represented by loop 1428. If required by the VCU monitor 1364 of the other VCU 1304a, 1304b, a the VCU 1304 1304a, 1304b can resend the amount of torque applied by the motor 1312a, 1312b or determined by the other VCU 1304a, 1304b. In some circumstances, the VCU monitor 1364 determines that the torque calculated by the other VCU 1304a, 1304b is not within tolerances. The VCU monitor 1364 can retrieve a torque rule 1352 associated with a torque limit 1344. Based on the torque response 1348 applicable to the situation, the VCU monitor 1364 may signal the opposite VCU 1304a, 1304b to resend a torque command, resend the amount of sensed or estimated torque, etc. in signals 1432a, 1432b. The VCU monitor 1364 can also command the other VCU 1304a, 1304b to cease operation in signal 1432a, 1432b. Working with the VCU monitor 1364, the PEU monitor 1356 may also command the opposite PEU 1308a, 1308b to cease operation in signals 1436, 1440.

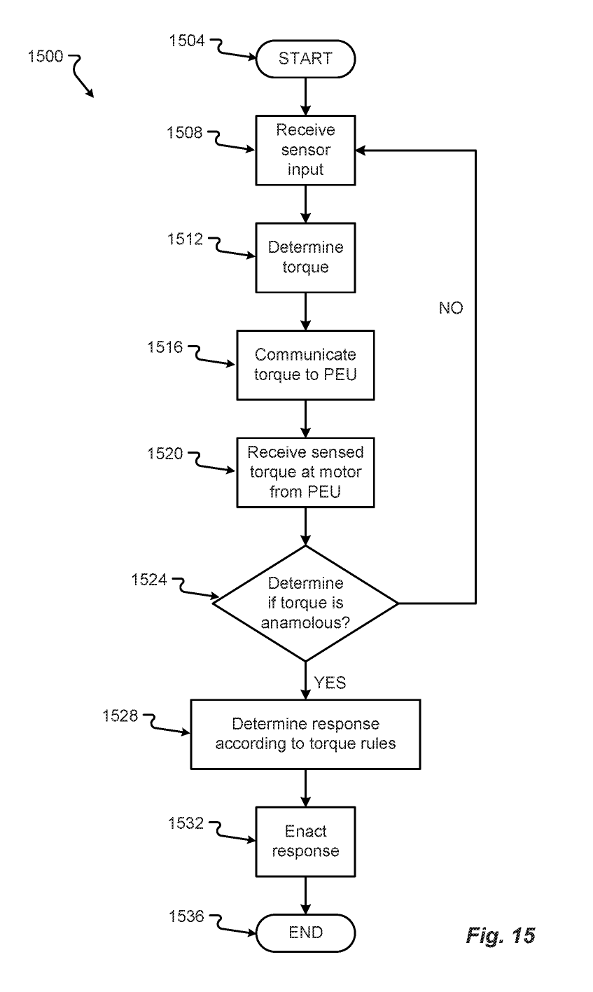

An embodiment of a method 1500 for controlling an electric vehicle 100 may be as shown in FIG. 15. The method 1500 may be from the perspective of a first VCU 1304a. A general order for the steps of the method 1500 is shown in FIG. 15. Generally, the method 1500 starts with a start operation 1504 and ends with an end operation 1536. The method 1500 can include more or fewer steps or can arrange the order of the steps differently than those shown in FIG. 15. The method 1500 can be executed as a set of computer-executable instructions executed by a computer system or processor and encoded or stored on a computer readable medium. Hereinafter, the method 1500 shall be explained with reference to the systems, components, circuits, modules, software, data structures, signaling processes, etc. described in conjunction with FIGS. 1-14.

A VCU 1304 can receive sensor input from one or more sensors 1320, in step 1508. The sensor input may be generated by sensors associated with one or more of the vehicle systems, for example, the braking system, the acceleration system, the transmission system etc. Based on the sensor input, from the sensors 1320, and from the vehicle driving context (a determination of the current driving state and changes to the state based on the driver's perceived desires, which may be determined by other systems or sensors), the torque calculator 1360 of the VCU 1304 can determine an amount of torque to be applied by the motor(s) 1312a, 1312b, in step 1512. The amount of calculated torque to be applied can be the torque required to meet the drivers perceived desires as based on the sensor inputs.

It should also be noted that a first VCU 1304a may receive duplicated sensor data from a second VCU 1304b. By receiving the duplicated sensor data, the first VCU 1304a may determine whether the second VCU 1304b is receiving corrupted or incorrect sensor data and react to this anomaly. For example, the first VCU 1304a may provide correct sensor data to the second VCU 1304b, reset or deactivate a sensor, reset the second VCU 1304b, etc.

The PEU monitor 1356 of the VCU 1304 may then communicate the amount of desired torque to the PEU 1308, through signal 1404, in step 1516. Thus, the PEU monitor 1356 of the VCU 1304 can send a command signal to the PEU 1308 to control or provide the motor 1312 with the proper amount of electricity to generate the desired torque. After the command signal 1404, the PEU monitor 1356 of the VCU 1304 can receive signal 1408 including the amount of sensed torque being generated by the motor(s) 1312a, 1312b, in step 1520. Thus, each PEU 1308a, 1308b can send the sensed torque through the signal path 1324, 1336, as signal 1408 and/or as other signals.

The PEU monitor 1356 of the VCU may then make a comparison between the received torque sensed by the PEUs 1308a, 1308b and the calculated torque requested of the PEUs 1308a, 1308b at least sent in signal 1404. The comparison can determine if the received torque and commanded torque are the same or similar. If the received torque and commended torque are not the same but are within some type of determined tolerance, for example, ±5%, the PEU monitor 1356 of the of the VCU 1304 may determine that the PEUs 1308a, 1308b and motors 1312a, 1312b are operating correctly. However, if the commanded torque, in at least signal 1404, and sensed torque are not the same or outside of acceptable tolerances, the PEU monitor 1356 of the VCU 1304 can determine that the torque is anomalous, in step 1524. If there is no anomaly with the received torque compared to the commanded torque, the method 1500 may proceed “NO” to step 1508. If there is a perceived anomaly, the method 1500 may proceed “YES” to step 1528.

The PEU monitor 1356 of the VCU 1304 may determine a response to the anomalous torque, based on one or more torque rules 1352, in step 1528. The PEU monitor 1356 of the VCU 1304 may retrieve the one or more torque rules 1352 from the torque rules data store 1340, which may be stored in memory 1136. The amount of discrepancy between the calculated torque and the sensed torque may be compared with the torque limits 1344 in one or more of the torque rules 1352. Based on whether the torque difference crosses a predetermined threshold, as defined in one or more of the torque limits 1344, the PEU monitor 1356 of the VCU 1304 may retrieve the required response from field 1348.

The PEU monitor 1356 of the VCU 1304 may then read and enact the retrieved response 1348, in step 1532. The required response 1348 can include sending a new command signal 1412 to one or more of the PEUs 1308a, 1308b. In other situations, the PEU monitor 1356 of the VCU 1304 may command one or more of the PEUs 1308a, 1308b to discontinue operation and stop powering the motor 1312. In still other situations, the PEU monitor 1356 of the VCU 1304 can request that PEU monitor 1356 of the resend the amount of torque calculated such that the PEU monitor 1356 of the VCU 1304 can conduct another comparison. There may be other types of responses as previously discussed in conjunction with FIGS. 13A-13C.

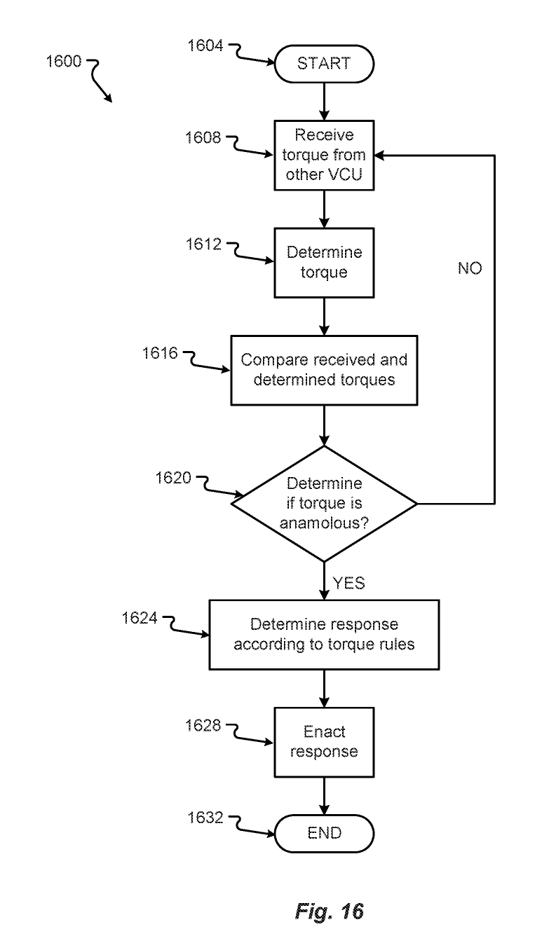

An embodiment of a method 1600 for controlling an electric vehicle 100 may be as shown in FIG. 16. The method 1600 may be from the perspective of a first VCU 1304a. A general order for the steps of the method 1600 is shown in FIG. 16. Generally, the method 1600 starts with a start operation 1604 and ends with an end operation 1632. The method 1600 can include more or fewer steps or can arrange the order of the steps differently than those shown in FIG. 16. The method 1600 can be executed as a set of computer-executable instructions executed by a computer system or processor and encoded or stored on a computer readable medium. Hereinafter, the method 1600 shall be explained with reference to the systems, components, circuits, modules, software, data structures, signaling processes, methods, etc. described in conjunction with FIGS. 1-15.

A VCU monitor 1364 of a first VCU 1304 a can receive an amount of torque calculated by a second VCU 1304b in signal 1420, in step 1608. The torque calculator 1360 of the first VCU 1304a may also calculate the amount of torque to be applied by the second motor 1312b based on the electrical signal sent by second PEU 1308b to the motor 1312b, in step 1612. Thus, similar to calculating the amount of torque for the first motor 1312a (as described in conjunction with FIG. 15), the torque calculator 1360 of the first VCU 1304a can also calculate an amount of torque required by a second motor 1312b. The received torque from the second VCU 1304b and or second PEU 1308b may then be compared to the determined torque calculated by the torque calculator 1360 of the first VCU 1304a, in step 1616.

Similar to the steps described in conjunction FIG. 15, the VCU monitor 1364 of the first VCU 1304a can determine if the torque calculated by the second VCU 1304b or provided by the second PEU 1308b is anomalous. The VCU monitor 1364 determines the amount of discrepancy between the torque calculated by the first VCU 1304a and the second VCU 1304b (or applied by the second PEU 1308b). If the amount of difference between the two torques is greater than some predetermined threshold, for example, ±5%, the VCU monitor 1364 of first VCU 1304 can determine that the torque calculated by the second VCU 1304b (or applied by the second PEU 1308b) is anomalous, in step 1620. If the torque calculated by the second VCU 1304b (or applied by the second PEU 1308b) is not anomalous, the method 1600 proceeds “NO” back to step 1608. However, if the determined torque difference calculated or determined by the above comparison made by the VCU monitor 1364 of the first VCU 1304a is anomalous, the method 1600 proceeds “YES” to step 1624.

In step 1624, the VCU monitor 1364 of the first VCU 1304a can determine a response to the anomalous torque based on one or more torque rules 1352 stored in the torque rules data store 1340. Similar to the process described in FIG. 15, the VCU monitor 1364 of the first VCU 1304a can retrieve the data structure 1340 and compare the amount of difference between the two torques to the one or more torque limits 1344. Based on which threshold 1344 the torque difference applies, the VCU monitor 1364 of the first VCU 1304a may then extract a response 1348 from the applicable torque rule 1352. The VCU monitor 1364 may then enact this response, in step 1628. The appropriate responses may include requesting another calculated torque from the second VCU 1304b, sending a command to cease operation of the second VCU 1304b, or conducting some other response.

It should be understood that the first VCU 1304a may also receive an sensed or estimated torque from the second PEU 1308b, over data path 1336. In this situation, the PEU monitor 1356 of the first VCU 1304a can determine whether the rear VCU 1304b is functioning properly based communications with the PEU 1308b rather than the VCU 1304b. The first VCU 1304a can make a comparison of the sensed or estimated torque received from the second PEU 1308b to the calculated torque determined by the torque calculator 1360 of the first VCU 1304a, like what is described in conjunction with FIG. 15. However, the response to an anomalous torque may be to command the second VCU 1304b of second PEU 1308b rather than commanding the first PEU 1308a.

Further, the second VCU 1304b can also control the second PEU 1308b and second motor 1312 in a similar process to that discussed in conjunction with FIG. 15 using signal path 1328. Also, the second VCU 1304b can evaluate the function of the first VCU 1304a, using signal path 1332, and/or monitor communications from the first VCU 1304a using methods as described in conjunction with FIG. 15 and/or FIG. 16. In this way, the redundant VCUs 1304a, 1304b function to control both the first PEU 1308a, first motor 1312a, the second PEU 1308b, and/or the second motor 1312b and ensure that any error or anomaly with either VCU 1304a or 1304b may be responded to by the redundant VCU 1304.

Any of the steps, functions, and operations discussed herein can be performed continuously and automatically.

Herein, an electronic control unit (ECU) may be defined as a generic term for any embedded system that controls one or more of the electrical system or subsystems in a transport vehicle. Types of ECU include vehicle control unit (VCU) (which controls the electric vehicle operation), Electronic/engine Control Module (ECM), Powertrain Control Module (PCM), Transmission Control Module (TCM), Brake Control Module (BCM or EBCM), Central Control Module (CCM), Central Timing Module (CTM), General Electronic Module (GEM), Body Control Module (BCM), Suspension Control Module (SCM), control unit, or control module. Taken together, these systems are sometimes referred to as the vehicle's computer (there may be no single computer but multiple processors). Sometimes one assembly incorporates several of the individual control units/modules (VCU/PCM is often for both engine and transmission).

The power electronics unit (PEU) can refer to, herein, to the application of solid-state electronics to the control and conversion of electric power for use by one or more vehicle systems, for example, the motor(s). The conversion of electrical power can be accomplished by various components, for example, with semiconductor switching devices, such as, diodes, thyristors, and/or transistors. An AC/DC converter (rectifier) or DC/AC converter (inverter) may be common power electronics devices found in the vehicle. In the vehicle, an example application is the variable speed drive (VSD) that is used to control an induction motor that drives the vehicle.

The exemplary systems and methods of this disclosure have been described in relation to vehicle systems and electric vehicles. However, to avoid unnecessarily obscuring the present disclosure, the preceding description omits several known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a vehicle, comprising: a first motor; a first vehicle control unit (VCU) in communication with the first motor to control a first function of the first motor; and a second VCU in communication with the first motor and the first VCU, wherein the second VCU controls the first motor if the first VCU fails.

Any of the one or more above aspects, further comprising a first power control unit (PCU) electrically connected to the first motor and in communication with the first VCU and second VCU, wherein the first PCU provides power input to the first motor based on commands from the first VCU or second VCU.

Any of the one or more above aspects, wherein the first VCU receives a signal from the first PCU indicating a first amount of torque provided by the first motor, wherein the first VCU determines a second amount of torque required by the first motor, wherein the first VCU compares the first amount of torque and the second amount of torque to determine if a failure has occurred with the first motor or the first PCU.

Any of the one or more above aspects, wherein the second VCU receives a first signal from the first VCU indicating a second amount of torque determined by the first VCU for the first motor, wherein the second VCU determines a third amount of torque required by the first motor, wherein the second VCU compares the third amount of torque and the second amount of torque to determine if a failure has occurred with the first VCU.

Any of the one or more above aspects, further comprising: a second motor; and wherein the second VCU is in communication with the second motor to control a second function of the second motor.

Any of the one or more above aspects, further comprising a second PCU electrically connected to the second motor and in communication with the first VCU and second VCU, wherein the second PCU provides power input to the second motor based on commands from the first VCU or second VCU.

Any of the one or more above aspects, wherein the second VCU receives a signal from the second PCU indicating a fourth amount of torque provided by the second motor, wherein the second VCU determines a fifth amount of torque required by the first motor, wherein the second VCU compares the fourth amount of torque and the fifth amount of torque to determine if a failure has occurred with the second motor or the second PCU.

Any of the one or more above aspects, wherein the first VCU receives a second signal from the second VCU indicating a fifth amount of torque determined by the second VCU for the second motor, wherein the first VCU determines a sixth amount of torque required by the second motor, wherein the first VCU compares the fifth amount of torque and the sixth amount of torque to determine if a failure has occurred with the second VCU.

Any of the one or more above aspects, further comprising a sensor associated with one or more of a brake input, an acceleration input, a transmission input, a traction control input, a vehicle stability input, and/or a steering input, wherein the sensor is in communication with each of the first VCU and second VCU to control the vehicle.

Any of the one or more above aspects, further comprising a memory in communication with the first VCU and second VCU, wherein the memory stores a rule instructing the first and/or second VCU on how to control the vehicle based on a context of the vehicle.

Embodiments also include a method for controlling an electric vehicle, comprising: a first vehicle control unit (VCU) receiving a first torque value from a second VCU controlling a first motor, wherein the first torque value is to be applied to the first motor; the first VCU calculating a second torque value for the first motor; the first VCU comparing the first torque value with the second torque value; if the first torque value and the second torque value are not similar, the first VCU determining that the first torque value is anomalous; the first VCU retrieving a torque rule associated with the anomaly; and based on the torque rule, enacting a response to the anomaly.

Any of the one or more above aspects, further comprising: the first VCU determining an amount of difference between the first torque value and a second torque value; if the amount of difference is below a first threshold, enacting a first response in a first torque rule; and if the amount of difference is above the first threshold, enacting a second response in a second torque rule.

Any of the one or more above aspects, wherein the first response is one of: a command from the first VCU to the second VCU to recalculate the first torque value; or a command from the first VCU to the second VCU to apply the second torque value calculated by the first VCU to the first motor.

Any of the one or more above aspects, wherein the second response is: a command from the first VCU to the second VCU to cease operation; and a command from the first VCU to the first motor to apply the second torque value calculated by the first VCU.

Any of the one or more above aspects, further comprising: the second VCU receiving a third torque value from the first VCU controlling a second motor, wherein the third torque value is to be applied to the second motor; the second VCU calculating a fourth torque value for the second motor; the second VCU comparing the third torque value with the fourth torque value; if the third torque value and the fourth torque value are not similar, the second VCU determining that the third torque value is anomalous; the second VCU retrieving a torque rule associated with the anomaly; and based on the torque rule, enacting a response to the anomaly.

Embodiments further include a non-transitory computer readable medium having stored thereon instructions that cause a first vehicle control unit to conduct a method for controlling an electric vehicle, the method comprising: receiving a first torque value from a second VCU controlling a first motor, wherein the first torque value is to be applied to the first motor; calculating a second torque value for the first motor; comparing the first torque value with the second torque value; if the first torque value and the second torque value are not similar, determining that the first torque value is anomalous; retrieving a torque rule associated with the anomaly; and based on the torque rule, enacting a response to the anomaly.

Any of the one or more above aspects, wherein the method further comprises: determining an amount of difference between the first torque value and a second torque value; if the amount of difference is below a first threshold, enacting a first response in a first torque rule; and if the amount of difference is above the first threshold, enacting a second response in a second torque rule.

Any of the one or more above aspects, wherein the first response is one of: a command from the first VCU to the second VCU to recalculate the first torque value; or a command from the first VCU to the second VCU to apply the second torque value calculated by the first VCU to the first motor.

Any of the one or more above aspects, wherein the second response is: a command from the first VCU to the second VCU to cease operation; and a command from the first VCU to the first motor to apply the second torque value calculated by the first VCU.

Any of the one or more above aspects, further comprising: the second VCU receiving a torque amount being supplied from a first power electronics unit (PEU) to the first motor; the second VCU comparing the torque amount with the first torque value; if the torque amount and the first torque value are not similar, the second VCU determining that an anomaly with the first PEU or the first motor; the second VCU retrieving a torque rule associated with the anomaly; and based on the torque rule, enacting a response to the anomaly.

Any one or more of the aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “electric vehicle” (EV), also referred to herein as an electric drive vehicle, may use one or more electric motors or traction motors for propulsion. An electric vehicle may be powered through a collector system by electricity from off-vehicle sources, or may be self-contained with a battery or generator to convert fuel to electricity. An electric vehicle generally includes a rechargeable electricity storage system (RESS) (also called Full Electric Vehicles (FEV)). Power storage methods may include: chemical energy stored on the vehicle in on-board batteries (e.g., battery electric vehicle or BEV), on board kinetic energy storage (e.g., flywheels), and/or static energy (e.g., by on-board double-layer capacitors). Batteries, electric double-layer capacitors, and flywheel energy storage may be forms of rechargeable on-board electrical storage.

The term “hybrid electric vehicle” refers to a vehicle that may combine a conventional (usually fossil fuel-powered) powertrain with some form of electric propulsion. Most hybrid electric vehicles combine a conventional internal combustion engine (ICE) propulsion system with an electric propulsion system (hybrid vehicle drivetrain). In parallel hybrids, the ICE and the electric motor are both connected to the mechanical transmission and can simultaneously transmit power to drive the wheels, usually through a conventional transmission. In series hybrids, only the electric motor drives the drivetrain, and a smaller ICE works as a generator to power the electric motor or to recharge the batteries. Power-split hybrids combine series and parallel characteristics. A full hybrid, sometimes also called a strong hybrid, is a vehicle that can run on just the engine, just the batteries, or a combination of both. A mid hybrid is a vehicle that cannot be driven solely on its electric motor, because the electric motor does not have enough power to propel the vehicle on its own.

The term “rechargeable electric vehicle” or “REV” refers to a vehicle with on board rechargeable energy storage, including electric vehicles and hybrid electric vehicles.

What is claimed is:

1-20. (canceled)

21. A vehicle, comprising:
a first motor;
a first vehicle control unit (VCU) in communication with the first motor to control a first function of the first motor; and
a second VCU in communication with the first motor and the first VCU, wherein the second VCU controls the first motor if the first VCU fails by determining an incorrect amount of torque to command from the first motor.

22. The vehicle of claim 21, further comprising a first power electronics unit (PEU) electrically connected to the first motor and in communication with the first VCU and second VCU, wherein the first PEU provides power input to the first motor based on commands from the first VCU or second VCU.

23. The vehicle of claim 22, wherein the first VCU receives a signal from the first PEU indicating a first amount of torque provided by the first motor, wherein the first VCU determines a second amount of torque required by the first motor, wherein the first VCU compares the first amount of torque and the second amount of torque to determine if a failure has occurred with the first motor or the first PEU.

24. The vehicle of claim 23, wherein the second VCU receives a first signal from the first VCU indicating a second amount of torque determined by the first VCU for the first motor, wherein the second VCU determines a third amount of torque required by the first motor, wherein the second VCU compares the third amount of torque and the second amount of torque to determine if a failure has occurred with the first VCU.

25. The vehicle of claim 24, further comprising:
a second motor; and
wherein the second VCU is in communication with the second motor to control a second function of the second motor.

26. The vehicle of claim 25, further comprising a second PEU electrically connected to the second motor and in communication with the first VCU and second VCU, wherein the second PEU provides power input to the second motor based on commands from the first VCU or second VCU.

27. The vehicle of claim 26, wherein the second VCU receives a signal from the second PEU indicating a fourth amount of torque provided by the second motor, wherein the second VCU determines a fifth amount of torque required by the first motor, wherein the second VCU compares the fourth amount of torque and the fifth amount of torque to determine if a failure has occurred with the second motor or the second PEU.

28. The vehicle of claim 27, wherein the first VCU receives a second signal from the second VCU indicating a fifth amount of torque determined by the second VCU for the second motor, wherein the first VCU determines a sixth amount of torque required by the second motor, wherein the first VCU compares the fifth amount of torque and the sixth amount of torque to determine if a failure has occurred with the second VCU.

29. The vehicle of claim 28, further comprising a sensor associated with one or more of a brake input, an acceleration input, a transmission input, a traction control input, a vehicle stability input, and/or a steering input, wherein the sensor is in communication with each of the first VCU and second VCU to control the vehicle.

30. The vehicle of claim 29, further comprising a memory in communication with the first VCU and second VCU, wherein the memory stores a rule instructing the first and/or second VCU on how to control the vehicle based on a context of the vehicle.

31. A method for controlling an electric vehicle, comprising:
a first vehicle control unit (VCU) receiving a first torque value from a second VCU controlling a first motor, wherein the first torque value is to be applied to the first motor;
the first VCU calculating a second torque value for the first motor;
the first VCU comparing the first torque value with the second torque value;
if the first torque value and the second torque value are not similar, the first VCU determining that the first torque value is anomalous;
the first VCU retrieving a torque rule associated with the anomaly; and
based on the torque rule, enacting a response to the anomaly.

32. The method of claim 31, further comprising:
the first VCU determining an amount of difference between the first torque value and a second torque value;
if the amount of difference is below a first threshold, enacting a first response in a first torque rule; and
if the amount of difference is above the first threshold, enacting a second response in a second torque rule.

33. The method of claim 32, wherein the first response is one of:
a command from the first VCU to the second VCU to recalculate the first torque value; or
a command from the first VCU to the second VCU to apply the second torque value calculated by the first VCU to the first motor.

34. The method of claim 33, wherein the second response is:
a command from the first VCU to the second VCU to cease operation; and
a command from the first VCU to the first motor to apply the second torque value calculated by the first VCU.

35. The method of claim 34, further comprising:
the second VCU receiving a third torque value from the first VCU controlling a second motor, wherein the third torque value is to be applied to the second motor;
the second VCU calculating a fourth torque value for the second motor;
the second VCU comparing the third torque value with the fourth torque value;
if the third torque value and the fourth torque value are not similar, the second VCU determining that the third torque value is anomalous;
the second VCU retrieving a torque rule associated with the anomaly; and
based on the torque rule, enacting a response to the anomaly.

36. A non-transitory computer readable medium having stored thereon instructions that cause a first vehicle control unit to conduct a method for controlling an electric vehicle, the method comprising:
receiving a first torque value from a second VCU controlling a first motor, wherein the first torque value is to be applied to the first motor;
calculating a second torque value for the first motor;
comparing the first torque value with the second torque value;
if the first torque value and the second torque value are not similar, determining that the first torque value is anomalous;
retrieving a torque rule associated with the anomaly; and
based on the torque rule, enacting a response to the anomaly.

37. The non-transitory computer readable medium of claim 36, wherein the method further comprises:
determining an amount of difference between the first torque value and a second torque value;
if the amount of difference is below a first threshold, enacting a first response in a first torque rule; and
if the amount of difference is above the first threshold, enacting a second response in a second torque rule.

38. The non-transitory computer readable medium of claim 37, wherein the first response is one of:
a command from the first VCU to the second VCU to recalculate the first torque value; or
a command from the first VCU to the second VCU to apply the second torque value calculated by the first VCU to the first motor.

39. The non-transitory computer readable medium of claim 38, wherein the second response is:
a command from the first VCU to the second VCU to cease operation; and
a command from the first VCU to the first motor to apply the second torque value calculated by the first VCU.

40. The non-transitory computer readable medium of claim 39, further comprising:
the second VCU receiving a torque amount being supplied from a first power electronics unit (PEU) to the first motor;
the second VCU comparing the torque amount with the first torque value;
if the torque amount and the first torque value are not similar, the second VCU determining that an anomaly with the first PEU or the first motor;
the second VCU retrieving a torque rule associated with the anomaly; and
based on the torque rule, enacting a response to the anomaly.
